(19) United States
(12) Patent Application Publication
(10) Pub. No.: US 2019/0287354 A1
(43) Pub. Date: Sep. 19, 2019

(54) SHOPPING ASSISTANCE SYSTEM

(71) Applicant: Panasonic Intellectual Property Management Co., Ltd., Osaka (JP)

(72) Inventors: KAZUHIKO YAHATA, Kanagawa (JP); SUGURU KOJIMA, Kanagawa (JP); TAKU SUZUYAMA, Kanagawa (JP); SHINICHI OKADA, Tokyo (JP); JUNICHI TAKAHASHI, Osaka (JP)

(21) Appl. No.: 16/430,389

(22) Filed: Jun. 3, 2019

Related U.S. Application Data
(63) Continuation of application No. PCT/JP2018/001113, filed on Jan. 17, 2018.

(30) Foreign Application Priority Data
Jan. 24, 2017 (JP) 2017-010709

(51) Int. Cl. G07G 1/00; G06K 7/10

(52) U.S. Cl. CPC G07G 1/009; B65D 25/205; G06K 7/10297

(57) ABSTRACT

A shopping assistance system includes a moving device (bagging device) and an information acquisition device. The moving device includes a support portion and a guide portion. The support portion is provided with a placement surface on which a product with an RF tag is placed. The guide portion includes a shielding space for shielding radio waves therein, and is disposed around the support portion along outer circumferential edges of the placement surface. The information acquisition device reads product information from the RF tag by performing wireless communication with the RF tag using an antenna when a relative positional relationship between a communication area of the antenna and the RF tag changes in the shielding space, the communication area being an area which is set around the antenna and in which wireless communication with the RF tag is performed.

### CROSS-REFERENCE TO RELATED APPLICATIONS

This application is a continuation of the PCT International Application No. PCT/JP2018/001113 filed on Jan. 17, 2018, which claims the benefit of foreign priority of Japanese patent application No. 2017-010709 filed on Jan. 24, 2017, the contents all of which are incorporated herein by reference.

### BACKGROUND

### 1. Technical Field

The present disclosure relates generally to a shopping assistance system, and more particularly to a shopping assistance system that acquires product information of a product.

### 2. Description of the Related Art

In Japanese Patent Unexamined Publication No. 5-89364, a system (POS system) aimed at unmanned stores without salespersons at a store is disclosed.

The system disclosed in Japanese Patent Unexamined Publication No. 5-89364 is configured with a basket for putting products and a transaction terminal device. The basket includes a scanner that reads product information (product data), and a transmission circuit that transmits the product information to the outside. The transaction terminal device includes a receiving circuit that receives the product information, a measurement device that measures a weight of products put in the basket, and a control unit that compares weight data corresponding to the product information with a measured value of the measurement device. The transaction terminal device performs settlement processing in a case where the measured value of the measurement device matches with the total weight of the weight data.

### SUMMARY

A shopping assistance system according to the present disclosure includes a moving device and an information acquisition device. The moving device includes a support portion, a guide portion, and a driving portion. The support portion is provided with a placement surface on which a product with an RF tag is placed. The guide portion includes a shielding space for shielding radio waves inside the guide portion, and is disposed around the support portion along outer circumferential edges of the placement surface. The driving portion drives the support portion so as to move the RF tag into the shielding space. The information acquisition device acquires product information of the product from the RF tag. The information acquisition device includes an antenna that emits radio waves for communication with the RF tag. The information acquisition device reads the product information from the RF tag by performing wireless communication with the RF tag using the antenna when a relative positional relationship between a communication area of the antenna and the RF tag changes in the shielding space, the communication area being an area which is set around the antenna and in which wireless communication with the RF tag is performed.

According to the shopping assistance system of each aspect of the present disclosure, it is possible to acquire product information of a product with high accuracy.

### BRIEF DESCRIPTION OF DRAWINGS

FIG. 1 is an external perspective view of a counter table to which a shopping assistance system according to an embodiment of the present disclosure is applied.

FIG. 2 is a block diagram of the shopping assistance system according to the embodiment of the present disclosure.

FIG. 3 is an external perspective view of a guide portion of the shopping assistance system according to the embodiment of the present disclosure.

FIG. 4 is a partially-broken perspective view illustrating a main part of a bagging system of the shopping assistance system according to the embodiment of the present disclosure.

FIG. 5A is an explanatory diagram of an operation when lowering a support portion of the shopping assistance system according to the embodiment of the present disclosure.

FIG. 5B is an explanatory diagram of an operation when lowering the support portion of the shopping assistance system according to the embodiment of the present disclosure.

FIG. 5C is an explanatory diagram of an operation when lowering the support portion of the shopping assistance system according to the embodiment of the present disclosure.

FIG. 6A is an explanatory diagram of an operation when closing a shutter of the shopping assistance system according to the embodiment of the present disclosure.

FIG. 6B is an explanatory diagram of an operation when closing the shutter of the shopping assistance system according to the embodiment of the present disclosure.

FIG. 6C is an explanatory diagram of an operation when closing the shutter of the shopping assistance system according to the embodiment of the present disclosure.

FIG. 7A is an explanatory diagram of an operation when lifting the support portion of the shopping assistance system according to the embodiment of the present disclosure.

FIG. 7B is an explanatory diagram of an operation when lifting the support portion of the shopping assistance system according to the embodiment of the present disclosure.

FIG. 7C is an explanatory diagram of an operation when lifting the support portion of the shopping assistance system according to the embodiment of the present disclosure.

FIG. 8A is an explanatory diagram of an operation of the shopping assistance system according to a first modification example of the embodiment of the present disclosure.

FIG. 8B is an explanatory diagram of an operation of the shopping assistance system according to the first modification example of the embodiment of the present disclosure.

FIG. 8C is an explanatory diagram of an operation of the shopping assistance system according to the first modification example of the embodiment of the present disclosure.

FIG. 9A is an explanatory diagram of an operation of the shopping assistance system according to a second modification example of the embodiment of the present disclosure.

FIG. 9B is an explanatory diagram of an operation of the shopping assistance system according to the second modification example of the embodiment of the present disclosure.

FIG. 9C is an explanatory diagram of an operation of the shopping assistance system according to the second modification example of the embodiment of the present disclosure.

FIG. 10A is a partially cutaway external perspective view of the guide portion of the shopping assistance system according to a third modification example of the embodiment of the present disclosure.

FIG. 10B is an enlarged view of a main part of the guide portion according to the third modification example of the embodiment of the present disclosure.

FIG. 11A is a top view of the guide portion, an antenna, and a spacer of the shopping assistance system according to a fourth modification example of the embodiment of the present disclosure.

FIG. 11B is a sectional view taken along a line 11B-11B of FIG. 11A.

FIG. 12 is an external view of the guide portion and the antenna of the shopping assistance system according to a fifth modification example of the embodiment of the present disclosure.

FIG. 13 is an external view of the guide portion and the antenna of the shopping assistance system according to a sixth modification example of the embodiment of the present disclosure.

FIG. 14A is an explanatory diagram of an operation of the shopping assistance system according to a seventh modification example of the embodiment of the present disclosure.

FIG. 14B is an explanatory diagram of an operation of the shopping assistance system according to the seventh modification example of the embodiment of the present disclosure.

FIG. 14C is an explanatory diagram of an operation of the shopping assistance system according to the seventh modification example of the embodiment of the present disclosure.

FIG. 15A is an explanatory diagram of an operation of the shopping assistance system according to an eighth modification example of the embodiment of the present disclosure.

FIG. 15B is an explanatory diagram of an operation of the shopping assistance system according to the eighth modification example of the embodiment of the present disclosure.

FIG. 16 is a partially-broken perspective view illustrating a main part of the bagging system of the shopping assistance system according to a ninth modification example of the embodiment of the present disclosure.

### DETAILED DESCRIPTION OF PREFERRED EMBODIMENTS

Prior to description of an embodiment, problems in related art will be briefly described.

In the system described in Japanese Patent Unexamined Publication No. 5-89364, when a customer put a product into a basket, a scanner of the basket needs to read product information.

In order to solve the problem, a technique of acquiring product information from a radio frequency (RF) tag attached to a product by radio waves emitted by an antenna, is considered.

However, in such a technique, a point (null point) in which product information cannot be read from the RF tag occurs because a radio wave directly received from the antenna and a radio wave reflected from a surrounding environment such as a wall or floor cancel each other out. In addition, in some cases, product information may be read from an unintended RF tag outside the basket. For this reason, there is a problem that product information cannot be accurately acquired from an RF tag attached to a product placed at a specific place (for example, a product put in a basket).

The present disclosure has been made in view of the problems, and an object of the present disclosure is to provide a shopping assistance system capable of acquiring product information of a product with high accuracy.

A shopping support system according to a first aspect of the present disclosure includes a moving device and an information acquisition device. The moving device includes a support portion, a guide portion, and a driving portion. The support portion is provided with a placement surface on which a product with an RF tag is placed. The guide portion includes a shielding space for shielding radio waves inside the guide portion, and is disposed around the support portion along outer circumferential edges of the placement surface. The driving portion drives the support portion so as to move the RF tag into the shielding space. The information acquisition device acquires product information of the product from the RF tag. The information acquisition device includes an antenna that emits radio waves for communication with the RF tag. The information acquisition device reads the product information from the RF tag by performing wireless communication with the RF tag using the antenna when a relative positional relationship between a communication area of the antenna and the RF tag changes in the shielding space, the communication area being an area which is set around the antenna and in which wireless communication with the RF tag is performed.

In the shopping assistance system according to a second aspect of the present disclosure, in the first aspect, the information acquisition device reads the product information from the RF tag by performing wireless communication with the RF tag using the antenna when the RF tag moves in the shielding space.

In the shopping assistance system according to a third aspect of the present disclosure, in the first or second aspect, a shopping basket is further included. The shopping basket includes a basket main body and a bottom portion, and allows the product to be put. The bottom portion is attached to the basket main body so as to open and close a lower opening portion of the basket main body. The product put in the shopping basket is placed on the placement surface. The moving device moves the RF tag into the shielding space via the lower opening portion when the bottom portion is opened.

In the shopping assistance system according to a fourth aspect of the present disclosure, in the first or second aspect, a shopping basket is further included. The shopping basket allows the product to be put. The moving device moves the RF tag into the shielding space together with the shopping basket.

In the shopping assistance system according to a fifth aspect of the present disclosure, in any one of the first to fourth aspects, the information acquisition device changes an intensity of the radio wave emitted by the antenna in accordance with shielding performance of the shielding space.

In the shopping assistance system according to a sixth aspect of the present disclosure, in any one of the first to fifth aspects, the guide portion has a shielding function of absorbing or reflecting the radio wave emitted by the antenna.

In the shopping assistance system according to a seventh aspect of the present disclosure, in the sixth aspect, the guide portion has a cylindrical shape, and includes a first opening portion and a second opening portion which face each other in a movement direction of the support portion.

In the shopping assistance system according to an eighth aspect of the present disclosure, in the seventh aspect, the support portion is formed of a material which absorbs or reflects the radio wave emitted by the antenna. The support portion closes the second opening portion of the guide portion when the RF tag moves into the shielding space.

In the shopping assistance system according to a ninth aspect of the present disclosure, in the seventh or eighth aspect, a shutter is further included. The shutter is formed of a material which absorbs or reflects the radio wave emitted by the antenna, and covers the first opening portion of the guide portion.

In the shopping assistance system according to a tenth aspect of the present disclosure, in any one of the seventh to ninth aspects, a shopping basket is further included. The shopping basket includes a basket main body and a bottom portion, and allows the product to be put.

The bottom portion is attached to the basket main body so as to open and close a lower opening portion of the basket main body. The bottom portion is formed of a material which absorbs or reflects the radio wave emitted by the antenna, and covers the first opening portion of the guide portion.

In the shopping assistance system according to an eleventh aspect of the present disclosure, in the tenth aspect, the information acquisition device changes an intensity of the radio wave emitted by the antenna in accordance with a member covering the first opening portion of the guide portion.

In the shopping assistance system according to a twelfth aspect of the present disclosure, in any one of the first to eleventh aspects, the antenna includes a plurality of antenna elements. The plurality of antenna elements are directive, and are disposed such that directions of directivity thereof are different from each other.

In the shopping assistance system according to a thirteenth aspect of the present disclosure, in any one of the first to twelfth aspects, the antenna includes a plurality of antenna elements. Each of the plurality of antenna elements has polarization characteristics, and the plurality of antenna elements are disposed such that polarization directions thereof are different from each other.

In the shopping assistance system according to a fourteenth aspect of the present disclosure, in the thirteenth aspect, radio waves emitted by the plurality of antenna elements are circularly-polarized waves or elliptically-polarized waves.

In the shopping assistance system according to a fifteenth aspect of the present disclosure, in any one of the first to third aspects, a packing device is further included. The packing device puts the product into a container when the moving device moves the RF tag into the shielding space.

In the shopping assistance system according to a sixteenth aspect of the present disclosure, in the fifteenth aspect, a sales system is further included. The sales system is configured to perform communication with a settlement processing system which performs settlement processing of the product based on the product information.

According to the shopping assistance system of each aspect of the present disclosure, it is possible to acquire product information of a product with high accuracy.

### (1) Outline

A shopping assistance system according to the present embodiment is, for example, a system that is applied to a retail store such as a convenience store, a supermarket, a department store, a drug store, a home electric appliance store, or a home center and that assists shopping of a customer at a store.

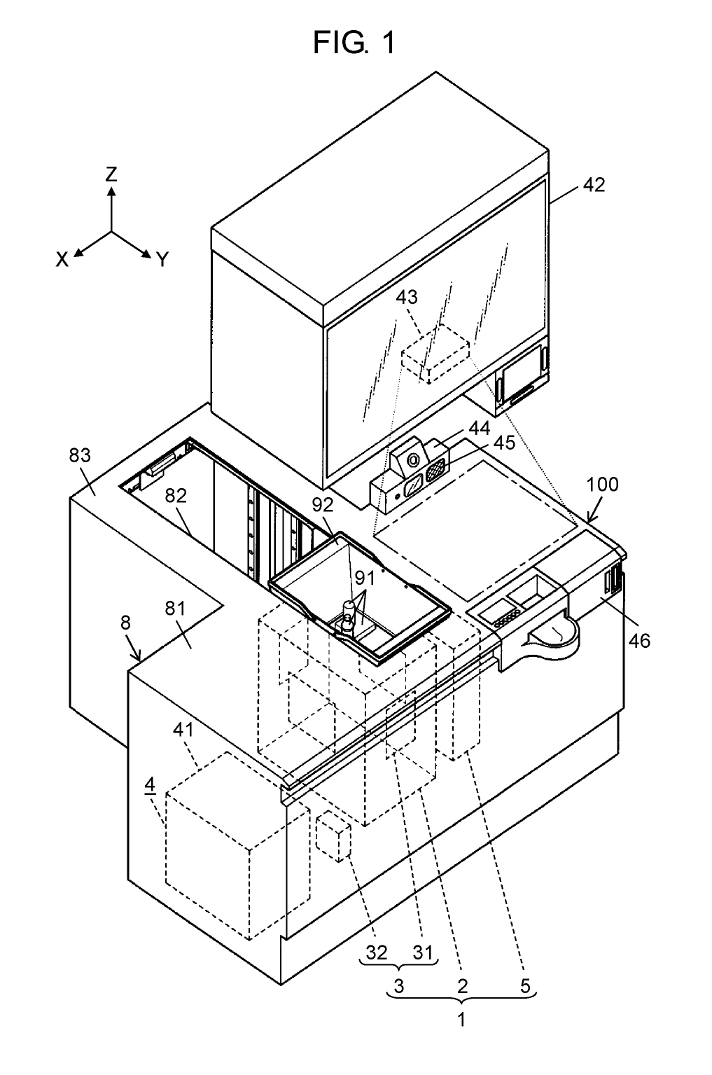

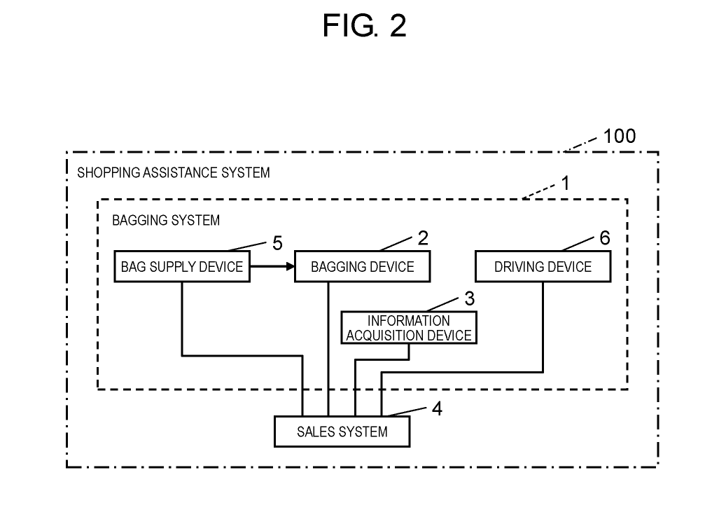

As illustrated in FIG. 1 and FIG. 2, shopping assistance system 100 includes bagging system 1, sales system 4, and shopping basket 92. Here, it is not essential that shopping basket 92 is included in components of shopping assistance system 100.

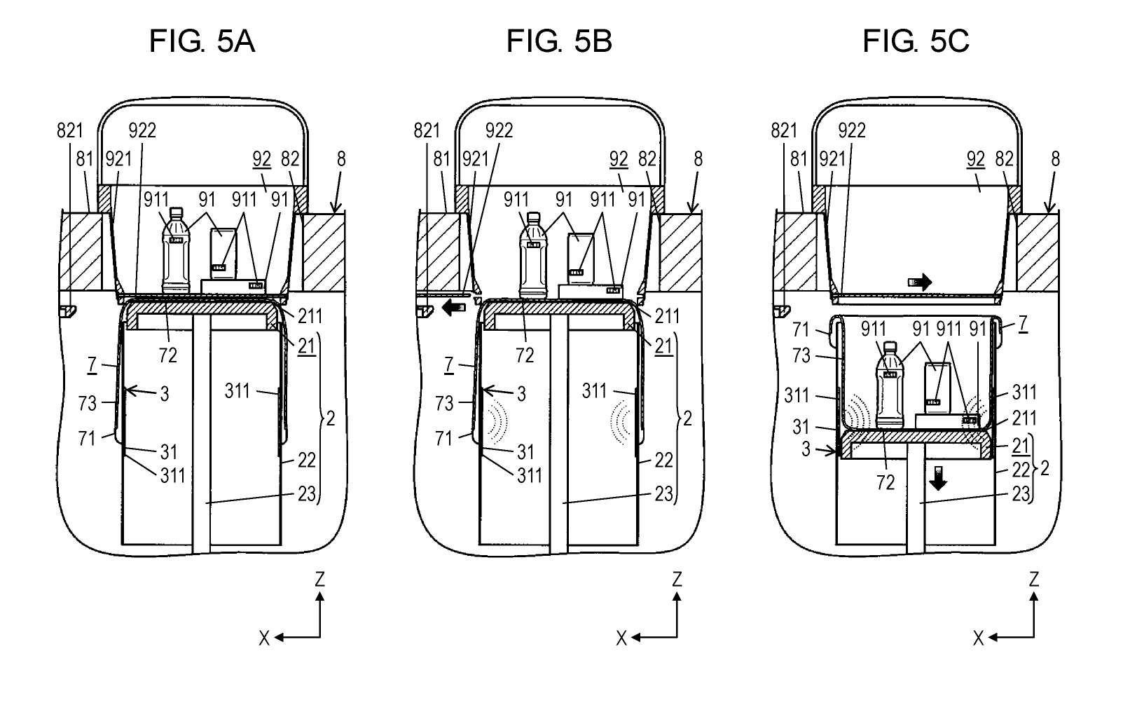

As illustrated in FIG. 1, bagging system 1 includes bagging device 2 (moving device) that performs bagging of product 91 (article), and information acquisition device 3 that acquires product information (article information) of product 91. Here, “bagging” means work of putting (inserting) one product 91 or a plurality of products 91 in bag 7 (refer to FIG. 5A). “bag” has a size for putting product 91, and may be a bag having a bag opening for putting and taking out product 91. For example, the bag is a shopping bag (so-called plastic bag) made of polyethylene or polypropylene.

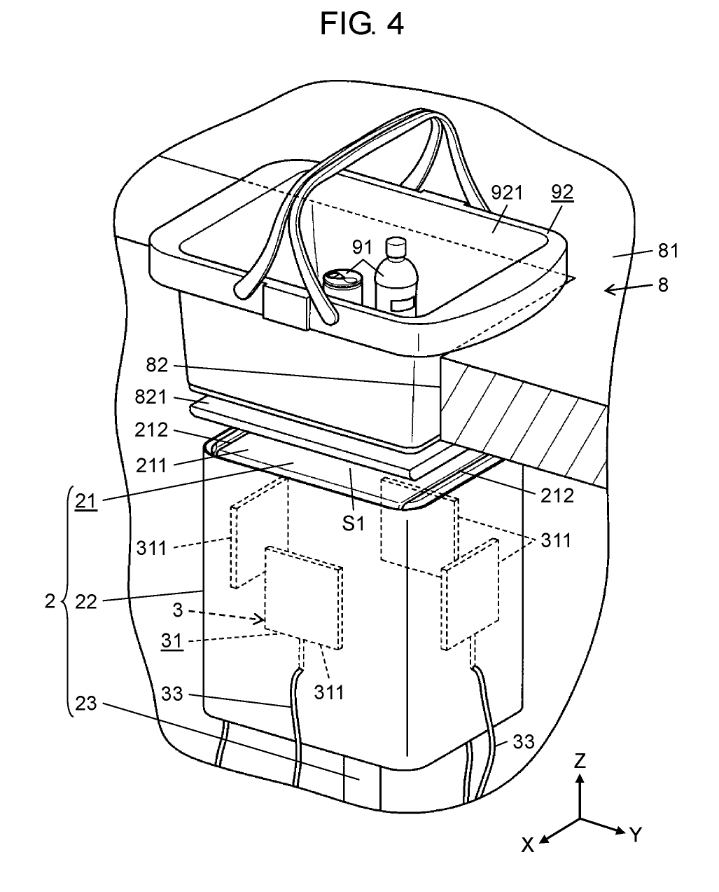

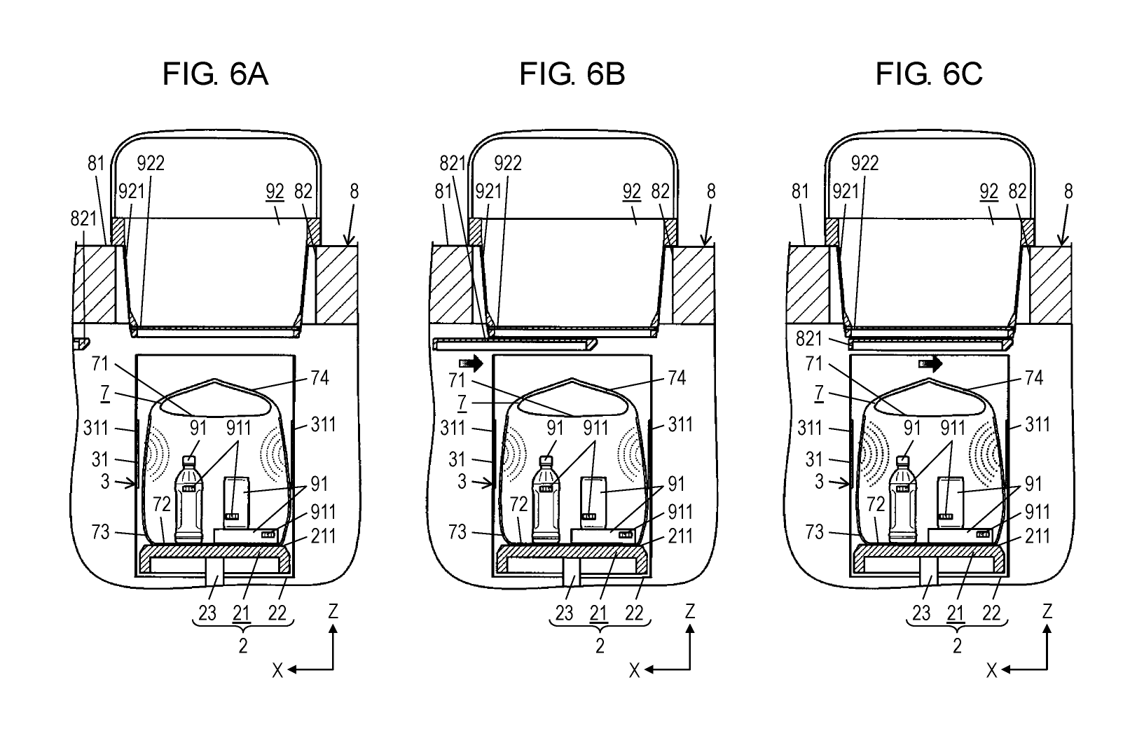

Bagging device 2 performs bagging of product 91 placed in predetermined bagging space S1 (refer to FIG. 4) set on placement surface 211 (refer to FIG. 4). Bagging device 2 is provided at, for example, a checkout counter of a store, and performs bagging of product 91 by transferring product 91 put in shopping basket 92 from shopping basket 92 to bag 7 (refer to FIG. 6A). Here, “bagging” includes not only bagging product 91 into bag 7, but also putting (inserting) product 91 into certain bag 7 for putting product 91. Thus, a customer can receive product 91 put in bag 7 by placing product 91 to be purchased in bagging space S1. Therefore, a customer or a store employee (salesperson) can reduce time and labor for bagging work by using bagging device 2.

Information acquisition device 3 acquires product information of product 91. Information acquisition device 3 acquires product information by reading the product information from radio frequency (RF) tag 911 attached to product 91. Here, “product information” is information for identifying product 91, and, for example, is product identification code such as a Japanese article number (JAN) code used in Japan. The product identification code includes, in addition to JAN code, European article number (EAN) code used in Europe and the like, and the universal product code (UPC) used in United States and the like.

Here, information acquisition device 3 reads product information when bagging device 2 performs bagging of product 91. That is, information acquisition device 3 reads product information from RF tag 911 (refer to FIG. 5A) attached to product 91, during a reading period from starting of bagging processing by bagging device 2 to discharging of bag 7 in which product 91 is put from bagging device 2. Further, information acquisition device 3 transmits the acquired product information to sales system 4.

Sales system 4 is a system for performing sales processing of product 91. Here, “sales processing” means various processing required for an act (selling) in which ownership of product 91 is transferred from a seller (a store) to a buyer (a customer) and the buyer pays a price (a payment) corresponding to product 91 to the seller. For example, the sales processing includes acquisition processing of acquiring product information of product 91 picked up by a customer in a store, order processing of inputting designation of the product desired to be purchased from a customer, and the like.

In shopping assistance system 100, bagging system 1 and sales system 4 cooperate with each other, and thus the following functions are realized.

That is, in a store to which shopping assistance system 100 is applied, a customer picks up one product 91 or a plurality of products 91 in the store, puts the product in shopping basket 92, places shopping basket 92 in bagging space S1, and then performs settlement of product 91 by sales system 4. At this time, bagging system 1 causes information acquisition device 3 to acquire product information while causing bagging device 2 to perform bagging of product 91. The product information acquired by information acquisition device 3 is transmitted from information acquisition device 3 to sales system 4, and thus settlement can be performed by sales system 4. Thereby, the customer can complete shopping in a series of flows of picking up product 91, performing settlement of product 91 by sales system 4, and then receiving product 91 in a bagged state. As a result, in a procedure in which the customer purchases product 91 at the store, intervention of a salesperson becomes unnecessary. Therefore, according to shopping assistance system 100, it is possible to reduce labor of a customer and a salesperson who is involved in shopping of the customer.

### (2) Details

Hereinafter, shopping assistance system 100 according to the present embodiment will be described in detail. In the present embodiment, a convenience store will be described as an example of a store to which shopping assistance system 100 is applied. In addition, in the present embodiment, a polyethylene shopping bag (so-called plastic bag) is used as an example of bag 7. Here, a person who places product 91 in bagging space S1 is not limited to a customer, and may be a salesperson. For example, in a case of a product such as a cigarette placed at a checkout counter, a salesperson, not a customer, places product 91 in bagging space S1.

(2.1) Shopping Assistance System

First, an overall configuration of shopping assistance system 100 according to the present embodiment will be described. As illustrated in FIG. 1 and FIG. 2, shopping assistance system 100 includes bagging system 1, sales system 4, and shopping basket 92. Here, it is not essential that shopping basket 92 is included in components of shopping assistance system 100.

(2.2) Sales System

Sales system 4 includes management apparatus 41, supply unit 42, display device 43, input device 44, sound output unit 45, and settlement unit 46. All of supply unit 42, display device 43, input device 44, sound output unit 45, and settlement unit 46 are peripheral devices of management apparatus 41, and are connected to management apparatus 41.

Management apparatus 41 receives the product information transmitted from bagging system 1 (information acquisition device 3). In addition, management apparatus 41 is configured to perform communication with a store terminal configured with, for example, a point of sales (POS) terminal. Management apparatus 41 can perform settlement processing of product 91 based on the product information received from bagging system 1. Further, management apparatus 41 is electrically connected to bagging device 2 and information acquisition device 3 of bagging system 1, and is configured to control bagging device 2 and information acquisition device 3.

Supply unit 42 is a device that supplies a specific product (for example, a cigarette) to a customer. Display device 43 is a device that performs various displaying for a customer. Input device 44 is a device that receives an operation of a customer by, for example, gesture detection or the like. In addition, input device 44 includes a microphone, and has a function of performing voice recognition processing and semantic analysis processing of a voice signal input from the microphone. Thus, a customer can also perform a voice operation (voice input). Sound output unit 45 includes a speaker, and is a device that provides various types of information to a customer using a sound.

That is, by using display device 43, input device 44, and sound output unit 45 as a user interface, sales system 4 can provide various types of information to a customer by a display or a voice, or receive an operation of a customer (including voice input). Here, providing of information by sales system 4 may be realized by at least one of a display and a voice, may be realized by one of a display and a voice, or may be realized by a combination of a display and a voice.

(2.3) Shopping Basket

As illustrated in FIG. 4 and FIG. 5A, shopping basket 92 includes basket main body 921 and bottom plate 922, and product 91 is put in shopping basket 92. A bottom surface of basket main body 921 is opened. Bottom plate 922 is configured to be slidable between a position at which the bottom surface (a lower opening) of basket main body 921 is closed and a position at which the bottom surface (a lower opening) of basket main body 921 is opened. That is, bottom plate 922 is attached to basket main body 921 such that the bottom surface of basket main body 921 is opened and closed. Thereby, the bottom surface of basket main body 921 can be opened and closed, and thus product 91 put in shopping basket 92 can be discharged from the bottom surface of basket main body 921.

(2.4) Bagging System

As described above, bagging system 1 includes bagging device 2 and information acquisition device 3.

Bagging device 2 can perform bagging of product 91 put in shopping basket 92. That is, the customer can cause bagging device 2 to perform bagging of product 91 by putting product 91 picked up in the store into shopping basket 92 and placing each shopping basket 92 with product 91 in bagging space S1 to be described below. Therefore, the customer does not need to take out product 91 from shopping basket 92 for bagging, and thus it is possible to easily perform bagging of product 91 using bagging device 2. In a case where a plurality of products 91 are put in shopping basket 92, bagging device 2 can collectively perform bagging of the plurality of products 91. In the present embodiment, while the customer performs order processing or the like by sales system 4, management apparatus 41 controls bagging system 1 by cooperation with sales system 4 such that bagging of product 91 and reading of product information are performed. For example, in response to starting of order processing by sales system 4, bagging system 1 starts bagging of product 91 and reading of product information.

In addition, bagging system 1 further includes bag supply device 5 that supplies bag 7 to bagging device 2. Bag supply device 5 takes out bag 7 one by one from a bag stocker in which a plurality of bags 7 are stocked, and supplies taken-out bag 7 to bagging device 2. In the present embodiment, management apparatus 41 controls bag supply device 5 by cooperation with bagging device 2 such that one bag 7 is always set (provided) in bagging device 2. That is, bagging device 2 is configured to perform bagging using one bag 7 supplied from bag supply device 5. Each time bagging device 2 performs bagging once, new bag 7 is supplied from bag supply device 5 to bagging device 2 one by one in preparation for next bagging. In other words, bag supply device 5 starts supplying of bag 7 to bagging device 2 in response to completion of bagging by bagging device 2.

In addition, bagging system 1 further includes driving device 6 that drives bottom plate 922 of shopping basket 92 and shutter 821 to be described below. In the present embodiment, management apparatus 41 controls driving device 6 by cooperation with bagging device 2.

On the other hand, as illustrated in FIG. 1, shopping assistance system 100 is provided, for example, in the vicinity of one counter table 8 provided at a checkout counter of a store, excluding shopping basket 92. That is, bagging system 1 and sales system 4 are provided in the vicinity of counter table 8. A plurality of counter tables 8 may be provided for one store.

In the example of FIG. 1, bagging system 1 and management apparatus 41 are incorporated in counter table 8.

Recess 82 as an opening is formed at a substantially-central portion of upper surface 81 of counter table 8 in a width direction (a lateral direction). Recess 82 forms bagging space S1. In the example of FIG. 1, shopping basket 92 is placed in recess 82 (that is, bagging space S1). On the other hand, when the customer moves in the store, the customer holds shopping basket 92 with his or her hand or use shopping basket 92 placed on a cart, and in this case, shopping basket 92 is not fixed at a designated position. Collecting device 83 that collects shopping basket 92 is disposed at the rear of recess 82 when counter table 8 is viewed from the front. Bagging device 2 is provided below recess 82.

Here, a bottom surface of recess 82 is configured with shutter 821 (refer to FIG. 4) which can be opened and closed. In a state where shutter 821 is opened, placement surface 211 of bagging device 2 positioned below recess 82 is exposed from the bottom surface of recess 82. Thus, in the state where shutter 821 is opened, when bottom plate 922 of shopping basket 92 placed in bagging space S1 is opened, product 91 in shopping basket 92 is discharged onto placement surface 211 of bagging device 2. Bagging device 2 performs bagging of product 91 placed on placement surface 211. Details will be described in a section “(3) Operation of Shopping Assistance System”. Therefore, it is possible to perform bagging of product 91 in shopping basket 92.

Bag supply device 5 is disposed on the right side of bagging device 2 when counter table 8 is viewed from the front.

Supply unit 42 is suspended from a ceiling so as to be disposed above counter table 8. Display device 43 is fixed to a lower surface of supply unit 42, and is configured to project an image on a screen by, for example, a projection mapping technique. Here, display device 43 projects an image on a right area of recess 82 on upper surface 81 of counter table 8 when counter table 8 is viewed from the front. That is, the right area of recess 82 on upper surface 81 of counter table 8 is served as a screen of display device 43. Input device 44 is provided on upper surface 81 of counter table 8 and at the rear of the screen when counter table 8 is viewed from the front. Sound output unit 45 is integrally provided to input device 44.

In addition, in shopping assistance system 100, positional relationships, shapes, and the like of the units are merely an example, and may be appropriately changed. For example, bagging device 2 and recess 82 may be disposed at one end portion (a left end portion or a right end portion) of counter table 8 in the width direction (lateral direction). Further, it is not an essential configuration for shopping assistance system 100 that recess 82 is formed on counter table 8. For example, bagging space S1 may be set on upper surface 81 of counter table 8.

In the following, it is assumed that counter table 8 is provided such that upper surface 81 of counter table 8 is on a horizontal plane unless otherwise noted. That is, a direction orthogonal to upper surface 81 of counter table 8 is a longitudinal direction (vertical direction). In addition, in the following, it is assumed that the width direction (lateral direction) of counter table 8 is “X-axis direction”, a depth direction (front-rear direction) of counter table 8 is “Y-axis direction”, and the longitudinal direction (vertical direction) of counter table 8 is “Z-axis direction”. That is, the X-axis direction, the Y-axis direction, and the Z-axis direction are directions orthogonal to each other. Further, in order to distinguish a positive direction and a negative direction of the Z-axis direction, based on the directions in FIG. 1, it is assumed that the positive direction of the Z-axis direction is “upward direction” and the negative direction of the Z-axis direction is “downward direction”. Similarly, in order to distinguish a positive direction and a negative direction of the X-axis direction, based on the directions in FIG. 1, it is assumed that the positive direction of the X-axis direction is “leftward direction” and the negative direction of the X-axis direction is “rightward direction”. Similarly, in order to distinguish a positive direction and a negative direction of the Y-axis direction, it is assumed that the positive direction of the Y-axis direction is “frontward direction” and the negative direction of the Y-axis direction is “rearward direction”. Arrows indicating “X-axis direction”, “Y-axis direction”, and “Z-axis direction” in the drawings are illustrated only for a purpose of explanation, and are not practical. Here, the directions are not intended to limit directions when using shopping assistance system 100. For example, shopping assistance system 100 may be used in a state where upper surface 81 of counter table 8 is slightly inclined with respect to the horizontal plane.

(2.5) Bagging Device

Next, bagging device 2 will be described in more detail.

As illustrated in FIG. 4, bagging device 2 according to the present embodiment includes support portion 21, guide portion 22, and lift portion 23 (driving portion).

Support portion 21 is formed in a rectangular plate shape. An upper surface of support portion 21 serves as placement surface 211 for placing product 91. Here, placement surface 211 has an oblong shape with rounded corners. Support portion 21 is formed of a material that absorbs or reflects radio waves emitted by antenna 31.

Guide portion 22 is formed in a cylindrical shape in which at least an upper surface between the upper surface and a lower surface is opened. In the present embodiment, guide portion 22 is formed in an angular cylindrical shape in which both of the upper surface and the lower surface are opened. The opening surface of guide portion 22 is formed to be larger than placement surface 211, and guide portion 22 is disposed around support portion 21 along outer circumferential edges of placement surface 211. Here, a shape of an inner circumferential edge of an upper end surface of guide portion 22 and a shape of the outer circumferential edge of placement surface 211 are similar to each other. A shielding space that shields radio waves is formed inside guide portion 22. In the shielding space, radio waves are prevented from propagating to the inside of the space from the outside of the space and to the outside of the space from the inside of the space.

Lift portion 23 changes a relative positional relationship between support portion 21 and guide portion 22, from a first state to a second state. Here, a state in which support portion 21 is positioned at an upper end portion of guide portion 22 is referred to as the first state. When the relative positional relationship between support portion 21 and guide portion 22 is in the first state, the upper surface (placement surface 211) of support portion 21 is positioned slightly above the upper end surface of guide portion 22. Therefore, in the first state, support portion 21 is disposed to close the opening on an upper surface of guide portion 22. The second state is a state in which a relative position of support portion 21 with respect to guide portion 22 is lower than the position in the first state.

In other words, support portion 21 relatively moves with respect to guide portion 22 in a space surrounded by guide portion 22. In the present embodiment, lift portion 23 downwardly moves only support portion 21 between support portion 21 and guide portion 22, and thus the relative positional relationship between support portion 21 and guide portion 22 is changed from the first state to the second state. That is, support portion 21 is configured to vertically move in cylindrical-shaped guide portion 22 fixed at a designated position, by lift portion 23.

More specifically, lift portion 23 includes a motor, and is realized by an appropriate mechanism such as a pantograph type mechanism, a rack-pinion type mechanism, or the like capable of linearly moving support portion 21 in the vertical direction by a driving force generated by the motor.

On the other hand, in the present embodiment, bagging device 2 includes holding mechanism 212 for holding bottom portion 72 of bag 7 on placement surface 211, in addition to support portion 21, guide portion 22, and lift portion 23. Holding mechanism 212 holds bottom portion 72 by picking-up bottom portion 72 of bag 7. At least while the relative positional relationship between support portion 21 and guide portion 22 is changed from the first state to the second state, bagging device 2 continues to hold bottom portion 72 of bag 7 on placement surface 211 by holding mechanism 212. Specifically, a pair of grooves (refer to FIG. 4) along the X-axis direction are formed at both end portions of the upper surface (placement surface 211) of support portion 21 in the Y-axis direction. Holding mechanism 212 is provided in each of the pair of grooves, and holds bottom portion 72 in the groove by pinching bottom portion 72 pushed into the groove. Pushing of bottom portion 72 into the groove is performed, for example, by a fin which downwardly protrudes from a lower surface of shutter 821.

(2.6) Information Acquisition Device

Next, information acquisition device 3 will be described in more detail.

Information acquisition device 3 is configured to acquire product information by reading product information from RF tag 911 (refer to FIG. 5A) attached to product 91 during the reading period. Here, “reading period” is a period for which product information is read by information acquisition device 3, and is a period from starting of bagging processing by bagging device 2 to discharging of bag 7 in which product 91 is put from bagging device 2. That is, information acquisition device 3 reads product information of product 91 from RF tag 911 attached to product 91 during the period (reading period) from a timing when bagging device 2 starts bagging of product 91 to a timing when product 91 is discharged from bagging device 2.

In the present embodiment, product information is stored in RF tag 911. Information acquisition device 3 is configured to read product information from RF tag 911 by performing wireless communication with RF tag 911. In short, in shopping assistance system 100 according to the present embodiment, information acquisition device 3 reads product information from the RF tag, which is RF tag 911 attached to product 91, in a noncontact manner, instead of reading product information directly from product 91.

Here, “RF tag” is, for example, a passive RF tag, and includes a memory for storing at least product information. A plurality of RF tags 911 are associated with the plurality of products 91 one by one. RF tag 911 stores product information of corresponding product 91, and RF tag 911 is attached to corresponding product 91.

RF tag 911 may be attached to product 91 in a state where RF tag 911 can be integrally handled with product 91, and there are various forms as specific forms in which RF tag 911 is attached to product 91. In the present embodiment, as an example, RF tag 911 has a seal shape and is attached to product 91. As another example, for example, RF tag 911 may be connected to product 91 by a string or the like, may be integrated with packaging of product 91, or may be incorporated in product 91.

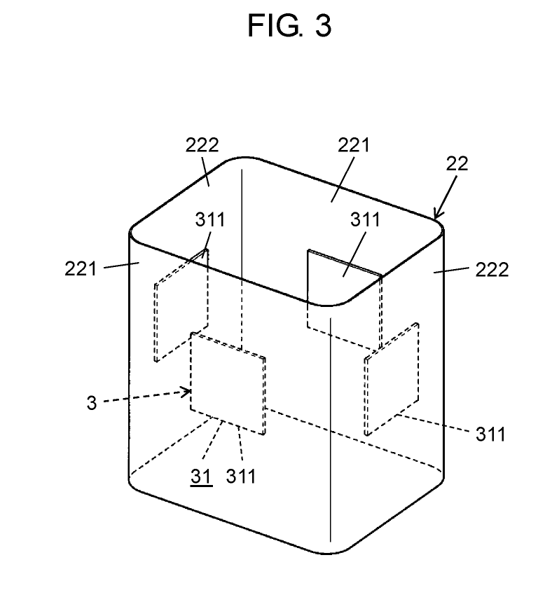

As illustrated in FIG. 3, information acquisition device 3 includes antenna 31 for performing communication with RF tag 911 and device main body 32 (refer to FIG. 1), and is a reader and writer of a radio frequency identification (RFID) system.

Antenna 31 is provided to guide portion 22 of bagging device 2. In the present embodiment, antenna 31 includes four patch antennas 311 (antenna elements) provided on inner surfaces of guide portion 22. Preferably, each patch antenna 311 is configured with a circularly-polarized-wave antenna in consideration of a polarization plane. Each patch antenna 311 may be configured with an elliptically-polarized-wave antenna. In addition, each patch antenna 311 may be configured with a linear polarization antenna having a polarization plane different from each other.

Four patch antennas 311 are respectively provided on four side walls 221, 221, 222, and 222 of guide portion 22 having an angular cylindrical shape. Four patch antennas 311 are directive, and are disposed such that directions of directivity thereof are different from each other. Each patch antenna 311 is electrically connected to device main body 32 by power supply line 33 (refer to FIG. 4). Information acquisition device 3 performs wireless communication by transmitting and receiving radio waves as a communication medium, to and from RF tag 911 by antenna 31, RF tag 911 being positioned in the shielding space as an internal space of guide portion 22.

Information acquisition device 3 reads product information from RF tag 911 by performing wireless communication with RF tag 911 using antenna 31 when a relative positional relationship between a communication area of antenna 31 and RF tag 911 changes in the shielding space of guide portion 22. The communication area of antenna 31 refers to an area which is set around antenna 31 and in which wireless communication with RF tag 911 is performed.

In the present embodiment, information acquisition device 3 reads product information from RF tag 911 by performing wireless communication with RF tag 911 using antenna 31 when RF tag 911 moves in the shielding space of guide portion 22.

Here, device main body 32 is configured to adjust an intensity of a radio wave (radio wave intensity) for communication with RF tag 911. In the present embodiment, device main body 32 selects and uses one radio wave intensity among a plurality of radio wave intensity levels such as “strong”, “medium”, and “weak”. In the plurality of radio wave intensity levels, as the radio wave intensity decreases in order of “strong”, “medium”, and “weak”, a reaching distance of a radio wave transmitted from antenna 31 becomes shorter. Therefore, for example, in a case where the radio wave intensity is “strong”, the radio wave reaches a position further away from antenna 31 compared to a case where the radio wave intensity is “weak”, and thus information acquisition device 3 can perform communication with RF tag 911 positioned further away from antenna 31. In addition, occurrence of a null point is suppressed.

In the present embodiment, device main body 32 is configured to change an intensity of a radio wave emitted from antenna 31 in accordance with a movement position of RF tag 911. For example, device main body 32 can change the radio wave intensity of antenna 31 in accordance with a member covering the opening surface on the upper surface of guide portion 22, that is, a shielding performance of the shielding space. In a case where only bottom plate 922 of shopping basket 92 covers the opening surface on the upper surface of guide portion 22, the radio wave intensity is set to “medium”. On the other hand, in a case where bottom plate 922 of shopping basket 92 and shutter 821 cover the opening surface on the upper surface of guide portion 22, the radio wave intensity is set to “strong”. In a case where the opening surface on the upper surface of guide portion 22 is not covered by bottom plate 922 or shutter 821, the radio wave intensity is set to “weak”.

In addition, information acquisition device 3 has a shielding function for restricting a reaching range of the radio wave for communication with RF tag 911. The shielding function is realized by shutter 821 serving as the bottom surface of recess 82, bottom plate 922 of shopping basket 92, guide portion 22, support portion 21, and the like. Details will be described later. As an example, a metal shield that shields radio waves is formed by metal deposition on surfaces of shutter 821, bottom plate 922, guide portion 22, support portion 21, and the like. Thereby, the radio wave for communication is prevented from being transmitted from antenna 31 more widely than necessary. Thus, for example, a product which is not to be bagged by bagging device 2, such as a product placed near counter table 8, can be excluded from targets of reading of product information.

### (3) Operation of Shopping Assistance System

Next, an operation of shopping assistance system 100 according to the present embodiment will be described with reference to FIG. 5A to FIG. 7C. In FIG. 5A to FIG. 7C, an operation of bagging system 1 of shopping assistance system 100 is schematically illustrated, and device main body 32, bag supply device 5, holding mechanism 212, and the like are not illustrated as appropriate.

FIG. 5A to FIG. 5C illustrate a procedure in which product 91 is put in bag 7 when the relative positional relationship between support portion 21 and guide portion 22 changes from the first state to the second state. In FIG. 5A to FIG. 5C, a plurality of products 91 such as a plastic bottle beverage, a boxed snack, and a canned juice are illustrated. On the other hand, the number of products 91 may be one.

First, when the relative positional relationship between support portion 21 and guide portion 22 is in the first state, as illustrated in FIG. 5A, bag 7 with bag opening 71 facing downward is put on support portion 21 and guide portion 22, and bottom portion 72 of bag 7 is supported by placement surface 211. Assuming that a state illustrated in FIG. 5A is a standby state, bagging device 2 waits in the standby state until shopping basket 92 in which product 91 is put is placed in bagging space S1 (in recess 82) on placement surface 211. In the present embodiment, in the standby state, shutter 821 serving as the bottom surface of recess 82 is in an opened state. Here, in the standby state, shutter 821 may be in a closed state. In this case, a position of support portion 21 in the standby state is slightly lower than a position in the state illustrated in FIG. 5A such that shutter 821 and support portion 21 do not interfere with each other. In this case, after shutter 821 is opened, support portion 21 may be lifted by a thickness of shutter 821 to fill a gap between bottom plate 922 of shopping basket 92 and placement surface 211.

When shopping basket 92 is placed in bagging space S1 (in recess 82), bagging processing by bagging device 2 is started. When the bagging processing is started, as illustrated in FIG. 5B, bottom plate 922 of shopping basket 92 is opened, and thus products 91 in shopping basket 92 are discharged onto placement surface 211 of bagging device 2. Thereby, products 91 are placed on placement surface 211 in bag 7. At this time, bottom portion 72 is held on placement surface 211 by a holding force of holding mechanism 212 in addition to weight of products 91. In the state illustrated in FIG. 5B, information acquisition device 3 starts reading of product information from RF tag 911. The radio wave intensity of information acquisition device 3 at this time is “weak”.

From this state (first state), lift portion 23 causes support portion 21 to move relatively downward with respect to guide portion 22, and thus, as illustrated in FIG. 5C, bag 7 is gradually drawn into the inside of guide portion 22. At this time, side circumferential portions 73 of bag 7 are drawn into the inside of guide portion 22 while being strained by the upper end surface of guide portion 22, side circumferential portions 73 being continuous to bottom portion 72 of bag 7. Accordingly, side circumferential portions 73 of bag 7 stand up above outer circumferential edges of bottom portion 72 by guide portion 22 around support portion 21.

Here, after product 91 is put inside guide portion 22, bottom plate 922 of shopping basket 92 is closed, and thus product 91 is put in a space surrounded by guide portion 22 and bottom plate 922 of shopping basket 92. When bottom plate 922 is completely closed, information acquisition device 3 switches the radio wave intensity from “weak” to “medium” and continues reading of the product information. That is, in a state where bottom plate 922 is opened, information acquisition device 3 sets the radio wave intensity to “weak”, thereby suppressing leakage of the radio wave to the outside of the space surrounded by guide portion 22. When bottom plate 922 is closed and thus shielding performance of the space surrounded by guide portion 22 increases, information acquisition device 3 sets the radio wave intensity to be stronger. As described above, in the present embodiment, information acquisition device 3 changes the radio wave intensity in accordance with the shielding performance of the space surrounded by guide portion 22.

In the state illustrated in FIG. 5C, lift portion 23 moves support portion 21, and thus the relative positional relationship between a communication area of antenna 31 and RF tag 911 changes, the communication area being an area which is set around antenna 31 and in which wireless communication with RF tag 911 is performed. In short, as radio waves are transmitted from antenna 31, around antenna 31, a communication area in which wireless communication with RF tag 911 is performed is set within at least the reaching range of the radio waves. As support portion 21 relatively moves with respect to guide portion 22 provided with antenna 31, a relative position of product 91 with respect to the communication area changes. That is, in the state of FIG. 5C, information acquisition device 3 reads product information from RF tag 911 when the relative positional relationship between the communication area set around antenna 31 and RF tag 911 changes.

When the relative positional relationship between support portion 21 and guide portion 22 becomes the second state, as illustrated in FIG. 6A, in the space surrounded by guide portion 22, bag 7 is turned over from the state of FIG. 5A, and product 91 is put in bag 7. At this time, side circumferential portions 73 are in a stand-up state along inner circumferential surfaces of guide portion 22. Here, in the second state, bagging device 2 is configured such that a height difference from placement surface 211 to the upper end surface of guide portion 22 is equal to or longer than a total length of bag 7 in a longitudinal direction. Here, “total length of bag 7 in a longitudinal direction” is a total length including a pair of handles 74 of bag 7, that is, a dimension from bottom portion 72 of bag 7 to tips of handles 74. Thereby, bag 7 is put in the space surrounded by guide portion 22 up to the tips of handles 74.

Therefore, bag 7 is in a stand-up state including not only side circumferential portion 73 but also handles 74.

As illustrated in FIG. 6B, driving device 6 drives shutter 821 such that the bottom surface of recess 82 is closed by shutter 821. While shutter 821 is moving, information acquisition device 3 continues reading of product information while maintaining the radio wave intensity to “medium”.

As illustrated in FIG. 6C, when shutter 821 is completely closed, product 91 is put in a space surrounded by guide portion 22, bottom plate 922 of shopping basket 92, and shutter 821. That is, the opening portion on the upper surface of guide portion 22 is closed by a double-structure lid of bottom plate 922 and shutter 821. When shutter 821 is completely closed, information acquisition device 3 switches the radio wave intensity from “medium” to “strong” and continues reading of the product information. That is, in a state where shutter 821 is opened, information acquisition device 3 sets the radio wave intensity to “medium”, thereby suppressing leakage of the radio wave to the outside of the space surrounded by guide portion 22. When shutter 821 is closed and thus shielding performance of the space surrounded by guide portion 22 increases, information acquisition device 3 sets the radio wave intensity to be stronger.

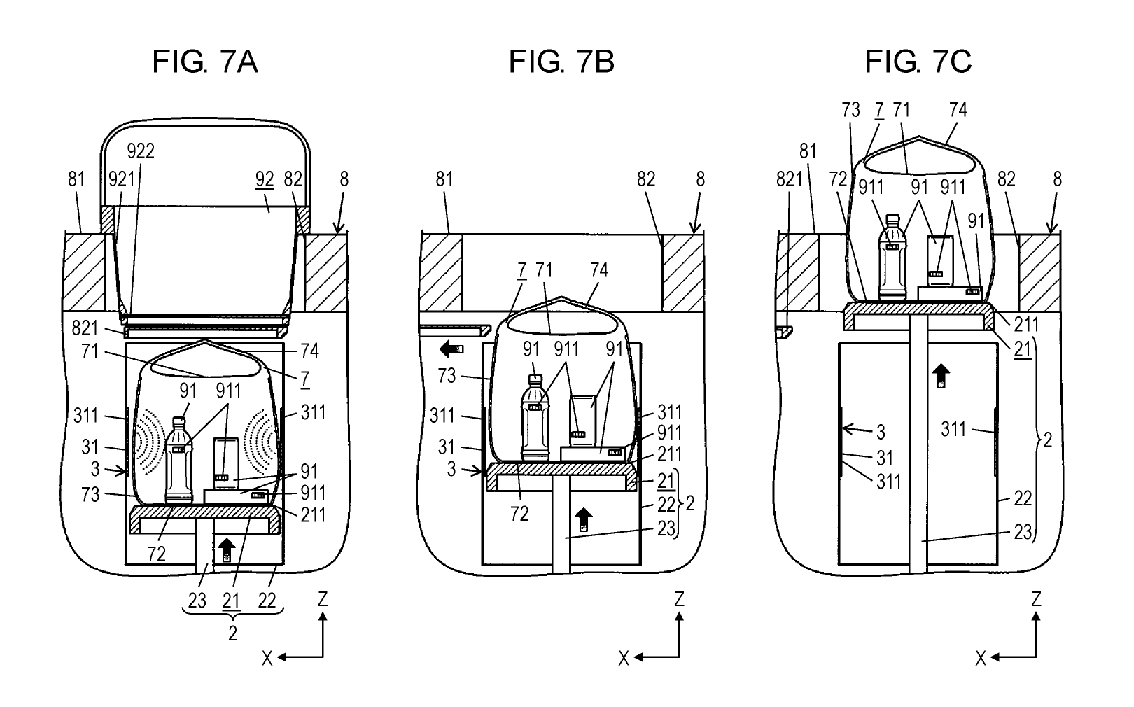

Thereafter, as illustrated in FIG. 7A, bagging device 2 causes lift portion 23 to move support portion 21 relatively upward with respect to guide portion 22. At this time, information acquisition device 3 continues reading of the product information while maintaining the radio wave intensity to “strong”. In the state illustrated in FIG. 7A, bagging processing by bagging device 2 is completed. When the bagging processing is completed, information acquisition device 3 ends reading of the product information by ending communication with RF tag 911, and transmits the acquired product information to sales system 4.

Here, in the state illustrated in FIG. 7A, lift portion 23 moves support portion 21, and thus the relative positional relationship between a communication area of antenna 31 and RF tag 911 changes, the communication area being an area which is set around antenna 31 and in which wireless communication with RF tag 911 is performed. That is, in the state of FIG. 7A, information acquisition device 3 reads product information from RF tag 911 when the relative positional relationship between the communication area set around antenna 31 and RF tag 911 changes.

Next, bagging device 2 causes lift portion 23 to drive support portion 21 such that the relative positional relationship between support portion 21 and guide portion 22 changes from the second state to the first state. Thereby, bag 7 is discharged from the space surrounded by guide portion 22. Here, as an example, in the procedure of FIG. 7B, shopping basket 92 is removed from above bagging device 2. On the other hand, a timing of removal of shopping basket 92 may be, for example, a timing before the procedure of FIG. 7B.

That is, as illustrated in FIG. 7B, as support portion 21 moves upward, bag 7 on placement surface 211 protrudes upward from the opening portion on the upper surface of guide portion 22. Further, as support portion 21 moves upward, as illustrated in FIG. 7C, bag 7 is completely discharged from the space surrounded by guide portion 22. At this time, bag 7 maintains a self-standing posture including handles 74. In addition, bag 7 supplied from bag supply device 5 is turned over from the state of FIG. 5A, and thus product 91 is put in bag 7. Therefore, in a case where a text or the like is printed on bag 7, preferably, reverse-printed bag 7 is used.

### (4) Modification Examples

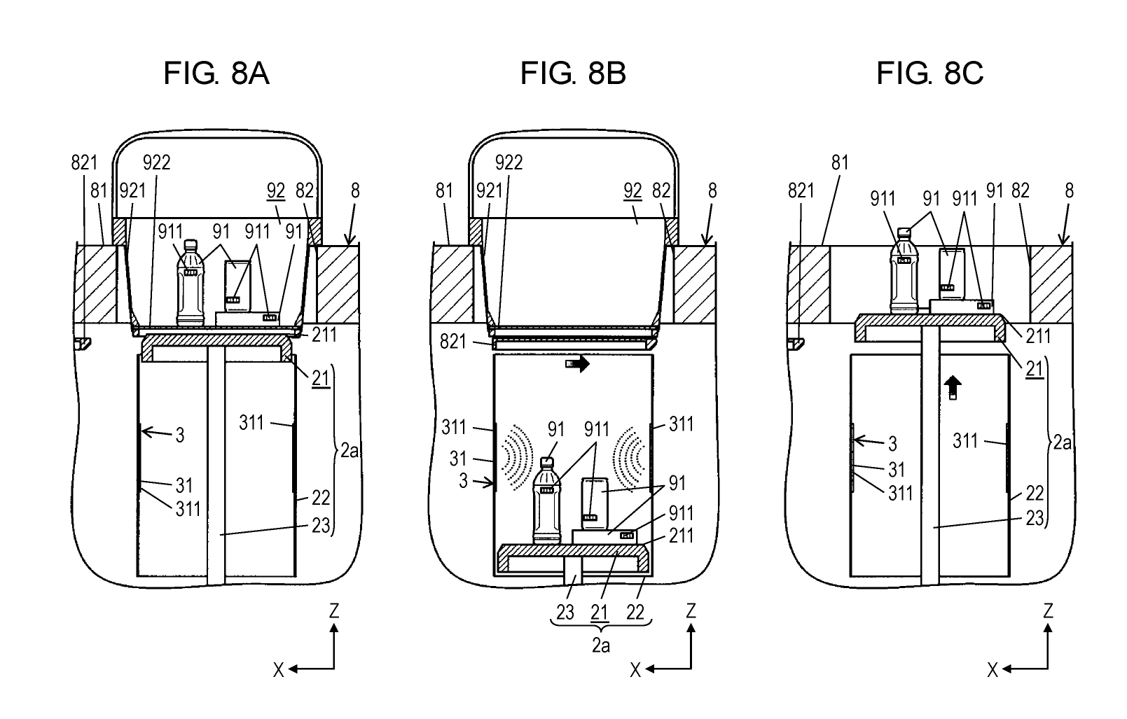

As a first modification example of the present embodiment, as illustrated in FIG. 8A to FIG. 8C, shopping assistance system 100 may perform bagging processing of putting product 91 in bag 7 when information acquisition device 3 acquires product information. Shopping assistance system 100 includes moving device 2a instead of bagging device 2. Similar to bagging device 2, moving device 2a includes support portion 21, guide portion 22, and lift portion 23. Here, moving device 2a does not have a function of performing bagging processing.

Hereinafter, an operation of shopping assistance system 100 according to the first modification example will be described. In FIG. 8A to FIG. 8C, an operation of shopping assistance system 100 according to the first modification example is schematically illustrated, and device main body 32, bag supply device 5, and the like are not illustrated as appropriate.

First, as illustrated in FIG. 8A, shopping basket 92 is placed on placement surface 211 on which bag 7 is not set. Thereafter, as in the present embodiment, bottom plate 922 of shopping basket 92 is opened, and thus products 91 in shopping basket 92 are discharged onto placement surface 211 (refer to FIG. 5B). In this state, information acquisition device 3 starts reading of product information from RF tag 911. The radio wave intensity of information acquisition device 3 at this time is “weak”.

From this state, lift portion 23 causes support portion 21 to move relatively downward with respect to guide portion 22 (refer to FIG. 5C). After product 91 is put inside guide portion 22, bottom plate 922 of shopping basket 92 is closed. As in the present embodiment, when bottom plate 922 is completely closed, information acquisition device 3 switches the radio wave intensity from “weak” to “medium” and continues reading of the product information. Thereafter, when the relative positional relationship between support portion 21 and guide portion 22 becomes the second state, driving device 6 drives shutter 821 such that the bottom surface of recess 82 is closed by shutter 821 (refer to FIG. 6A and FIG. 6B).

Thereafter, as illustrated in FIG. 8B, when shutter 821 is completely closed, product 91 is put in a space surrounded by guide portion 22, bottom plate 922 of shopping basket 92, and shutter 821. That is, the opening portion on the upper surface of guide portion 22 is closed by a double-structure lid of bottom plate 922 and shutter 821. When shutter 821 is completely closed, information acquisition device 3 switches the radio wave intensity from “medium” to “strong” and continues reading of the product information.

Thereafter, as in the present embodiment, moving device 2a causes lift portion 23 to move support portion 21 relatively upward with respect to guide portion 22 (refer to FIG. 7A). In this state, information acquisition device 3 ends reading of the product information by ending communication with RF tag 911, and transmits the acquired product information to sales system 4. Thereafter, shutter 821 is opened (refer to FIG. 7B).

Next, as illustrated in FIG. 8C, moving device 2a causes lift portion 23 to drive support portion 21 such that the relative positional relationship between support portion 21 and guide portion 22 changes from the second state to the first state. Thereby, product 91 is discharged from the space surrounded by guide portion 22.

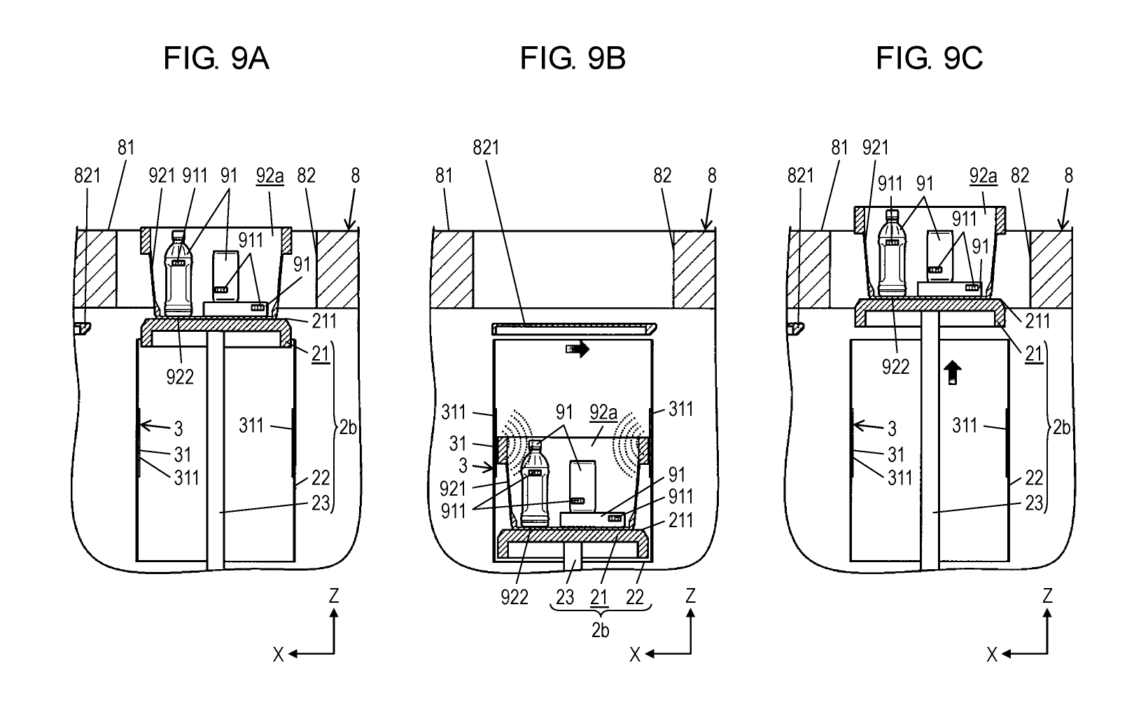

As a second modification example of the present embodiment, as illustrated in FIG. 9A to FIG. 9C, shopping assistance system 100 may move product 91 together with shopping basket 92a. Shopping assistance system 100 includes moving device 2b instead of bagging device 2. Similar to bagging device 2, moving device 2b includes support portion 21, guide portion 22, and lift portion 23. Here, moving device 2b does not have a function of performing bagging processing. Moving device 2b is configured to move product 91 to the shielding space of guide portion 22 together with shopping basket 92a. Thereby, in the second modification example, unlike the present embodiment, there is no need to open and close bottom plate 922 of shopping basket 92a, and thus, in shopping basket 92a, basket main body 921 and bottom plate 922 are integrally provided. In addition, since shopping basket 92a also moves to the shielding space of guide portion 22 together with product 91, preferably, shopping basket 92a according to the second modification example is smaller than shopping basket 92 according to the present embodiment.

Hereinafter, an operation of shopping assistance system 100 according to the second modification example will be described. In FIG. 9A to FIG. 9C, an operation of shopping assistance system 100 according to the second modification example is schematically illustrated, and device main body 32, bag supply device 5, and the like are not illustrated as appropriate.

First, as illustrated in FIG. 9A, shopping basket 92a is placed on placement surface 211 on which bag 7 is not set. Thereafter, information acquisition device 3 starts reading of product information from RF tag 911. The radio wave intensity of information acquisition device 3 at this time is “weak”.

From this state, lift portion 23 causes support portion 21 to move relatively downward with respect to guide portion 22. Shopping basket 92a in which product 91 is put is put inside guide portion 22. At this time, information acquisition device 3 continues reading of the product information while maintaining the radio wave intensity to “weak”. Thereafter, when the relative positional relationship between support portion 21 and guide portion 22 becomes the second state, driving device 6 drives shutter 821 such that the bottom surface of recess 82 is closed by shutter 821.

Thereafter, as illustrated in FIG. 9B, when shutter 821 is completely closed, product 91 is put in a space surrounded by guide portion 22 and shutter 821. At this time, information acquisition device 3 switches the radio wave intensity from “weak” to “strong”, and continues reading of the product information. Thereafter, moving device 2b causes lift portion 23 to move support portion 21 relatively upward with respect to guide portion 22. Before shutter 821 is opened, information acquisition device 3 ends communication with RF tag 911, and transmits the acquired product information to sales system 4.

Thereafter, as illustrated in FIG. 9C, shutter 821 is opened, and moving device 2b changes the relative positional relationship between support portion 21 and guide portion 22 from the second state to the first state. Thereby, shopping basket 92a in which product 91 is put is discharged from the space surrounded by guide portion 22.

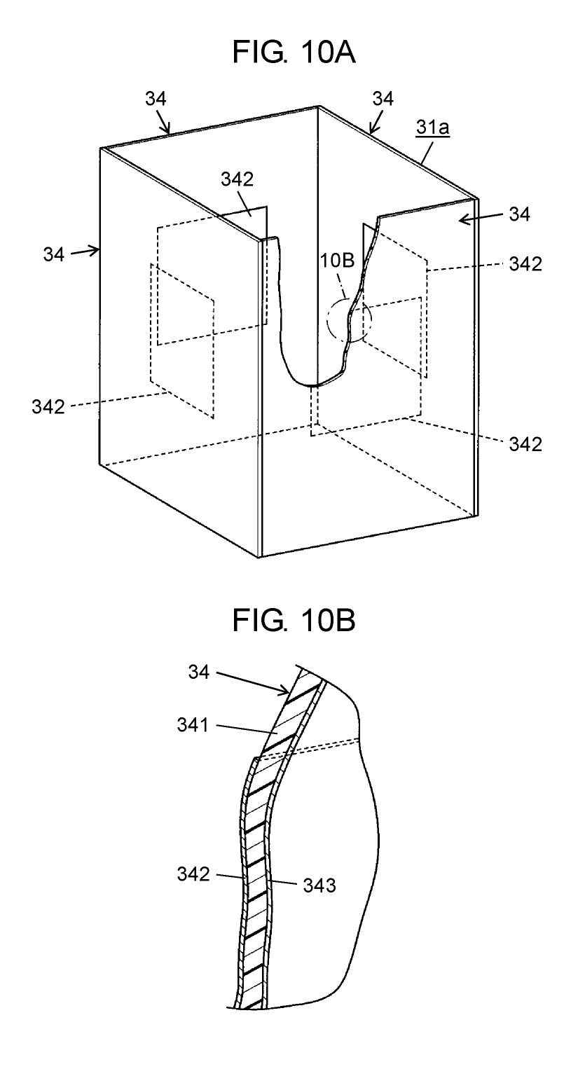

As a third modification example of the present embodiment, information acquisition device 3 of shopping assistance system 100 may have antenna 31a as illustrated in FIG. 10A and FIG. 10B instead of antenna 31 (refer to FIG. 3). FIG. 10A is a partially cutaway external perspective view of the guide portion of the shopping assistance system according to the third modification example. FIG. 10B is an enlarged view of area 10B of FIG. 10A, and illustrates a cross-section of the vertically cutaway part.

Antenna 31a according to the third modification example includes four patch antennas 34 (antenna elements). Each patch antenna 34 includes dielectric substrate 341, radiation element 342, and conductor 343 serving as a ground. Four patch antennas 34 serve as a guide portion by being combined so as to face each other two by two. That is, each patch antenna 34 constitutes a side wall of the guide portion having an angular cylindrical shape. Antenna 31a according to the third modification example serves both as antenna 31 and guide portion 22 according to the present embodiment. Thereby, it is possible to reduce a thickness of the side wall of the guide portion.

Further, in a case of using antenna 31a according to the third modification example, even when RF tag 911 contacts with the inside of antenna 31a serving as the guide portion, RF tag 911 can be separated from conductor 343 by a thickness of dielectric substrate 341. Thereby, it is possible to improve a reading rate of the product information from RF tag 911.

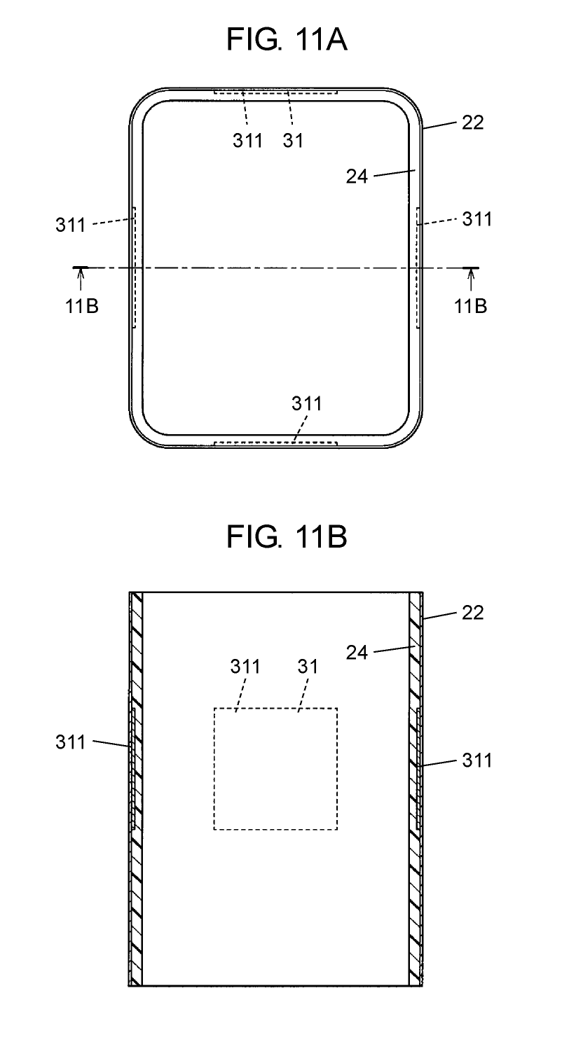

As a fourth modification example of the present embodiment, as illustrated in FIG. 11A and FIG. 11B, spacer 24 may be provided inside guide portion 22.

Spacer 24 is made of, for example, an insulating synthetic resin such as an ABS resin, and is provided over the entire inner circumferential surface of guide portion 22. Each patch antenna 311 of antenna 31 is provided between guide portion 22 and spacer 24. Spacer 24 is not limited to being provided over the entire inner circumferential surface of guide portion 22, and may be provided on only a portion of the inner circumferential surface of guide portion 22.

As illustrated to FIG. 11A and FIG. 11B, by providing spacer 24 inside guide portion 22, it is possible to reduce contact between RF tag 911 and the conductor (guide portion 22, antenna 31). Thereby, it is possible to improve a reading rate of the product information from RF tag 911.

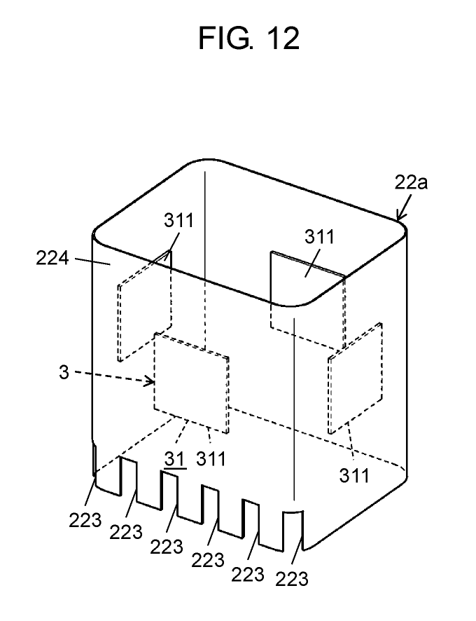

As a fifth modification example of the present embodiment, shopping assistance system 100 may include guide portion 22a as illustrated in FIG. 12 instead of guide portion 22 (refer to FIG. 3). Guide portion 22a includes a plurality of (in FIG. 12, six) slits 223. The plurality of slits 223 are formed on a lower portion of one side wall 224 of guide portion 22a. The plurality of slits 223 may be formed on two or more side walls instead of being formed on only one side wall 224 of guide portion 22a. For example, slits 223 may be formed on all the side walls of guide portion 22a. In addition, the number of slits 223 is not limited to plurality, and only one slit 223 may be formed.

As illustrated in FIG. 12, by forming slits 223 on guide portion 22a, it is possible to reduce reflected radio waves reflected by side wall 224 of guide portion 22a. Further, it is possible to reduce contact between RF tag 911 and guide portion 22a. Thereby, it is possible to improve a reading rate of the product information from RF tag 911.

Slits 223 according to the fifth modification example may be applied to a configuration in which spacer 24 (refer to FIG. 11A) as in the fourth modification example is provided.

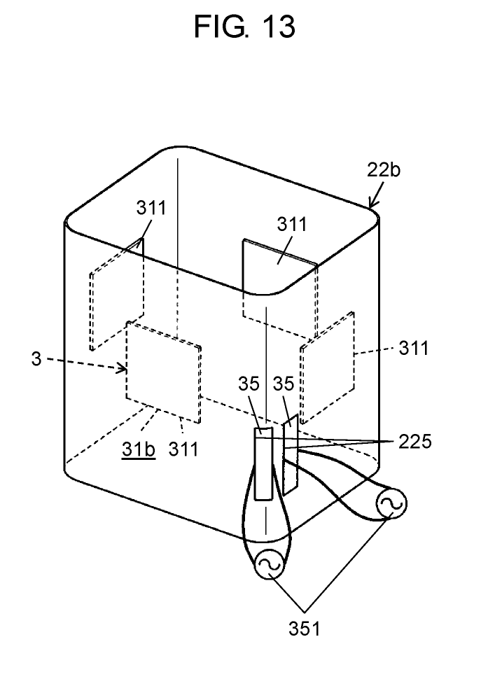

As a sixth modification example of the present embodiment, as illustrated in FIG. 13, antenna 31b of information acquisition device 3 may further include two slot antennas 35 together with four patch antennas 311. Each slot antenna 35 is provided on guide portion 22b including two slots 225. Each slot antenna 35 includes power supply unit 351, and power supply unit 351 is connected to power supply line 33 (refer to FIG. 4). Each slot antenna 35 also operates as an antenna while having the same effect as that of slit 223 (refer to FIG. 12) according to the fifth modification example. Thereby, it is possible to further improve a reading rate of the product information from RF tag 911. In a case of emitting circularly-polarized radio waves, slot antennas 35 may be disposed in a cross shape. In addition, antenna 31b is not limited to a combination of patch antenna 311 and slot antenna 35, and may include only slot antenna 35. The number of slot antennas 35 is not limited to two, and may be one, or three or more.

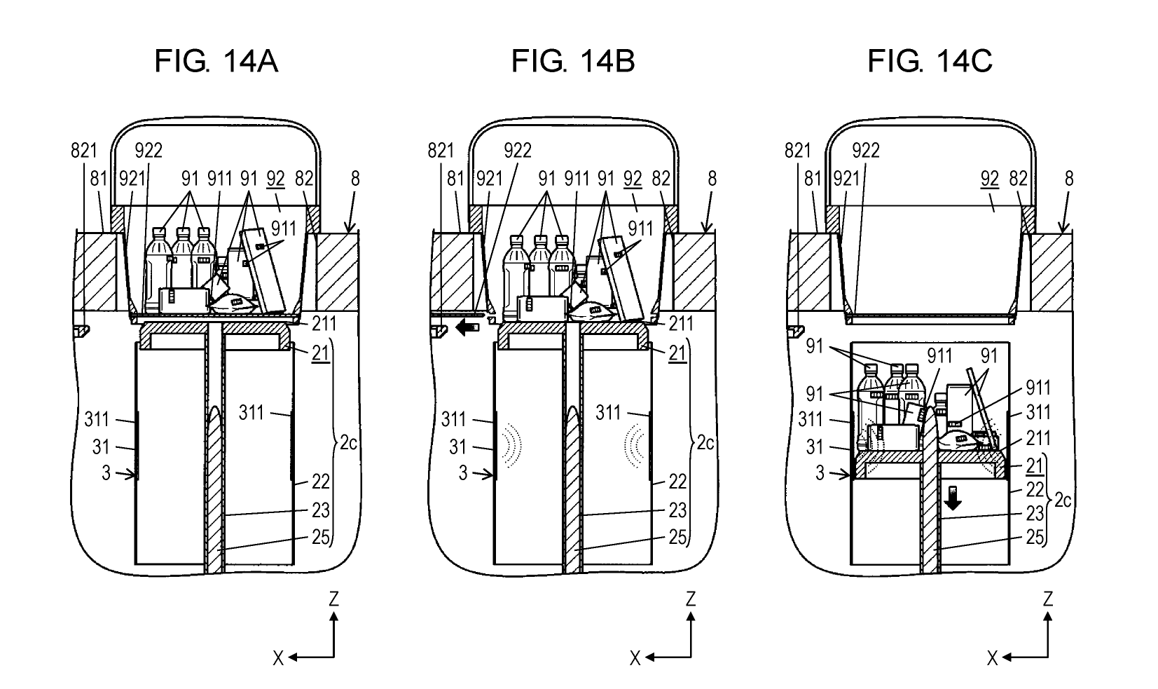

As a seventh modification example of the present embodiment, shopping assistance system 100 may include moving device 2c as illustrated in FIG. 14A to FIG. 14C instead of bagging device 2. Similar to bagging device 2, moving device 2c includes support portion 21, guide portion 22, and lift portion 23. Further, moving device 2c includes protrusion 25. Protrusion 25 upwardly protrudes from placement surface 211 of support portion 21 when the relative positional relationship between support portion 21 and guide portion 22 changes from the first state to the second state.

Hereinafter, an operation of shopping assistance system 100 according to the seventh modification example will be described. In FIG. 14A to FIG. 14C, an operation of shopping assistance system 100 is schematically illustrated, and device main body 32, bag supply device 5, and the like are not illustrated as appropriate.

First, when the relative positional relationship between support portion 21 and guide portion 22 is the first state, as illustrated in FIG. 14A, shopping basket 92 is placed on placement surface 211 on which bag 7 is not set. Thereafter, as illustrated in FIG. 14B, bottom plate 922 of shopping basket 92 is opened, and thus products 91 in shopping basket 92 are discharged onto placement surface 211 of bagging device 2. In the state illustrated in FIG. 14B, information acquisition device 3 starts reading of product information from RF tag 911. The radio wave intensity of information acquisition device 3 at this time is “weak”.

From this state, when lift portion 23 moves support portion 21 relatively downward with respect to guide portion 22, as illustrated in FIG. 14C, protrusion 25 disposed inside lift portion 23 protrudes from placement surface 211 of support portion 21. As protrusion 25 protrudes from placement surface 211, the plurality of products 91 on placement surface 211 are dispersed. Thereby, it is possible to prevent RF tags 911 of the plurality of products 91 from being overlapped with each other, and prevent RF tag 911 of one product 91 from being overlapped with a metal portion of another product 91. Thereby, it is possible to improve a reading rate of the product information from RF tag 911.

A linear antenna may be provided in protrusion 25. Thereby, it is possible to further improve a reading rate of the product information from RF tag 911.

In addition, in a case where product 91 is bagged into bag 7 as in the present embodiment, a protrusion amount of protrusion 25 may be smaller than that of the protrusion of FIG. 14C such that bag 7 is not torn.

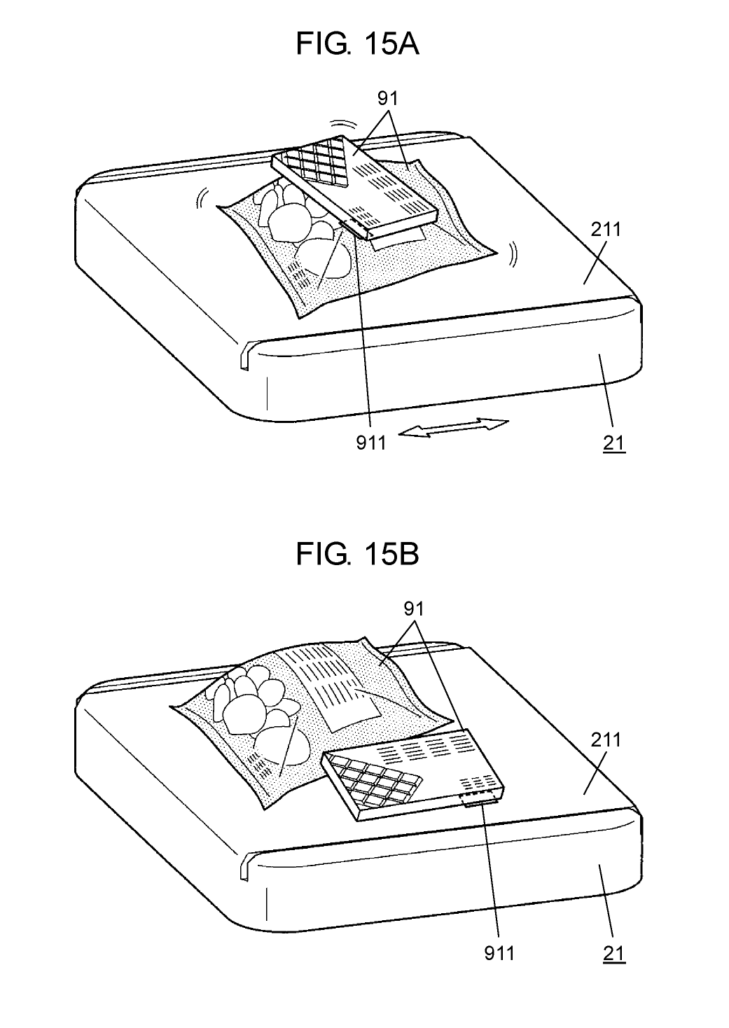

As an eighth modification example of the present embodiment, as illustrated in FIG. 15A and FIG. 15B, shopping assistance system 100 may include a mechanism which vibrates support portion 21 in a horizontal direction (arrow direction of FIG. 15A). That is, shopping assistance system 100 is configured to vibrate the plurality of products 91 placed on placement surface 211.

As illustrated in FIG. 15A, when RF tag 911 of one product 91 is in contact with, for example, an aluminum package of another product 91 such as potato chips, it may be difficult to read product information from RF tag 911. In this case, by vibrating placement surface 211 in the horizontal direction, as illustrated in FIG. 15B, the positional relationship between two products 91 can be changed. Thereby, it is possible to prevent RF tag 911 of one product 91 from being in contact with an aluminum package of another product 91.

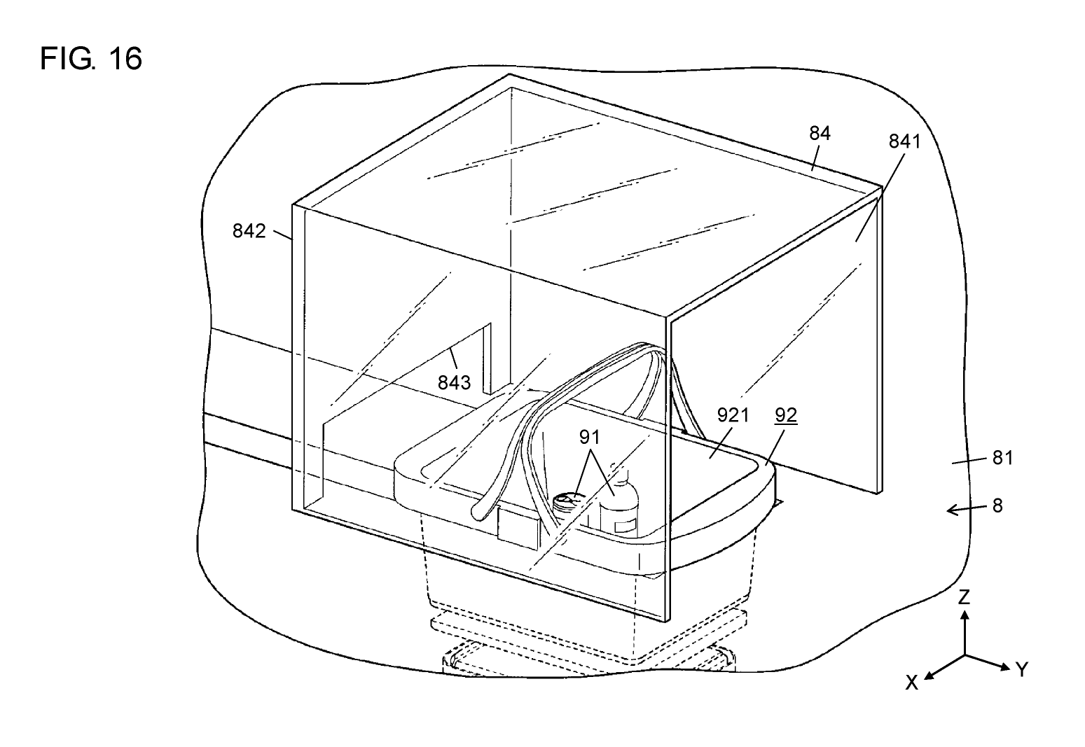

As a ninth modification example of the present embodiment, shopping assistance system 100 may include cover 84 as illustrated in FIG. 16.

Cover 84 includes a molded body formed of a transparent resin and a transparent conductive film attached to the molded body. Cover 84 covers at least a portion around shopping basket 92 placed on placement surface 211 of support portion 21. Cover 84 illustrated in FIG. 16 includes opening portion 841 allowing a customer to place shopping basket 92 therein, on the front side (right side in FIG. 16) when viewed by the customer. In addition, in order to collect shopping basket 92, recess 843 is formed on a lower portion of back surface 842 on the rear side (left side in FIG. 16) when viewed by a customer.

As cover 84 illustrated in FIG. 16 is provided, it is possible to further suppress leakage of radio waves emitted from antenna 31 into guide portion 22. In addition, since cover 84 has a light-transmitting property, even when cover 84 is provided, it is possible to prevent a customer from feeling oppression. Cover 84 may be formed of a metal body that reflects radio waves, or may be formed of a radio wave absorbing body that absorbs radio waves.

Bagging device 2 can perform bagging not only product 91 put in shopping basket 92 but also product 91 which is not put in shopping basket 92. In this case, by directly placing product 91 in bagging space S1, a customer can cause bagging device 2 to perform bagging of product 91.

In addition, antenna 31 is not limited to the configuration including four patch antennas 311, and may be configured with three or less, or five or more patch antennas 311. Further, the plurality of patch antennas 311 may be provided on the same surface of the inner surfaces of guide portion 22, or may be provided on a pair of surfaces facing each other. One pair of patch antennas 311 provided on the pair of surfaces facing each other may be in a positional relationship of being mutually shifted in a direction intersecting with the facing direction. Further, patch antennas 311 may be provided not only on guide portion 22 but also, for example, on support portion 21 or shutter 821.

In addition, shielding of shutter 821, bottom plate 922, guide portion 22, and support portion 21 is not limited to metal deposition. For example, shutter 821, bottom plate 922, guide portion 22, and support portion 21 may be configured with metal shields, or metal plates attached to shutter 821, bottom plate 922, guide portion 22, and support portion 21 may be served as shields. Further, for example, a metal shield may be formed on at least a portion of counter table 8, such as inner surfaces of recess 82. The shield is not limited to a metal shield, and may be made of, for example, a radio wave absorbing body that absorbs radio waves.

In addition, antenna 31 is not limited to a patch antenna, and may be a monopole antenna or an inverted-F antenna.

In addition, RF tag 911 is not limited to a passive RF tag, and may be an active RF tag.

In addition, a configuration for changing the relative position of product 91 with respect to the communication area is not limited to the configuration in which lift portion 23 moves support portion 21. For example, a configuration of mechanically moving antenna 31 or a configuration of moving the communication area by beam forming may be used.

In addition, it is not essential that information acquisition device 3 changes the radio wave intensity in accordance with the shielding performance of the space surrounded by guide portion 22, and the radio wave intensity may be constant. Information acquisition device 3 may change the radio wave intensity in a stepless manner in accordance with the shielding performance of the space surrounded by guide portion 22. Furthermore, the shielding performance of the space surrounded by guide portion 22 may be changed by not only opening/closing of bottom plate 922 and shutter 821, but also, for example, the relative positional relationship between support portion 21 and guide portion 22 (antenna 31).

Further, shopping basket 92 has not only a function of putting product 91 picked up by the customer in the store, may have but also a function of reading product information from each of the plurality of products 91 and transmitting a plurality of pieces of product information of the plurality of products 91 to sales system 4. Shopping basket 92 reads the product information by, for example, at least one means of an RF tag, a barcode, a two-dimensional code, and image recognition. In this case, in sales system 4, by using both of the product information read by shopping basket 92 and the product information acquired by information acquisition device 3, it is possible to enhance reliability of the product information.

Further, the usage of shopping assistance system 100 is not limited to a convenience store, and shopping assistance system 100 may be provided at a store other than a convenience store. Further, bagging system 1 may be provided, for example, in facilities other than a store, such as a factory, an office, and a delivery center. In facilities other than a store, product information acquired by information acquisition device 3 of shopping assistance system 100 is used, for example, for tracking of bagged product 91, quality control, sorting, or the like. That is, for example, in a factory, in a case where manufactured product 91 is bagged, it is possible to track product 91 by the product information of bagged product 91.

Further, in sales system 4, in a case where a contract for sales processing is not established, shopping assistance system 100 may not perform delivering of product 91 to the customer. For example, in a case where product 91 which cannot be sold for a minor customer, such as a liquor, is included, or in a case where a customer cancels purchase of product 91, purchase cancellation processing is performed by sales system 4. In this case, product 91 is returned to the store without being delivered to the customer.

In addition, bagging device 2 may be configured to put product 91 in bag 7. For example, bagging device 2 may be configured to put (bag) product 91 in bag 7 such as an eco-bag or a net bag regardless of a shopping bag as described above. A material of the shopping bag is not limited to polyethylene, and may be, for example, polypropylene.

In addition, shopping assistance system 100 may not be used together with sales system 4 configured to allow purchase of product 91 without requiring an operation of a salesperson as in the embodiment. For example, shopping assistance system 100 may be used in a situation where a salesperson is present at a checkout counter as in a so-called manned checkout.

In addition, it is not an essential configuration for shopping assistance system 100 that bagging system 1 and sales system 4 are integrated in one housing (counter table 8), and, for example, the components of shopping assistance system 100 may be provided being distributed in a plurality of housings.

In addition, bag supply device 5 may be configured to supply turned-over bag 7 to bagging device 2. In this case, turned-over bag 7 is set in bagging device 2, and then product 91 is put in turned-over bag 7. Thus, an original outer surface of bag 7 becomes an outer surface of bag 7 in which product 91 is put. Therefore, in a case where a text and the like are printed on bag 7, it is not necessary to use reverse-printed bag 7.

In addition, holding mechanism 212 of bagging device 2 is not limited to the configuration of holding bottom portion 72 by picking-up bottom portion 72 of bag 7 as in the embodiment. For example, a configuration of holding bottom portion 72 on placement surface 211 by suction of a vacuum suction pad or the like may be used.

In addition, in a case where a plurality of types of bags 7 having different sizes or colors are used, preferably, bag supply device 5 is configured to select one bag 7 from the plurality of types of bags 7 as needed, and supply the selected bags 7 to bagging device 2.

In addition, bagging device 2 may change the relative positional relationship between support portion 21 and guide portion 22 from the first state to the second state, for example, by moving guide portion 22 instead of support portion 21. For example, bagging device 2 may change the relative positional relationship between support portion 21 and guide portion 22 from the first state to the second state, by moving both of support portion 21 and guide portion 22.

Further, it is not an essential configuration for shopping support system 100 that shopping basket 92 includes basket main body 921 and bottom plate 922. A configuration of shopping basket 92 may be changed as appropriate. For example, shopping basket 92 may be configured to discharge product 91 in shopping basket 92 by tilting entire shopping basket 92.

Further, it is not an essential configuration for shopping support system 100 that sales system 4 (management apparatus 41) can perform communication with a store terminal. Sales system 4 may not perform communication with a store terminal. For example, sales system 4 itself may have a function of performing settlement processing of product 91 based on the product information.

In addition, shopping basket 92 is not limited to the configuration that a customer can hold with his or her hand. For example, basket main body 921 integrated with a cart may be used.

The above-described various modification examples can be appropriately combined and applied.

### (5) Summary

As described above, shopping assistance system (100) according to a first aspect of the present disclosure includes moving device (bagging device 2 or moving device 2a, 2b, or 2c) and information acquisition device (3). The moving device includes support portion (21), guide portion (22, 22a, or 22b), and driving portion (lift portion 23). Support portion (21) is provided with placement surface (211) on which product (91) with RF tag (911) is placed. Guide portion (22, 22a, or 22b) includes a shielding space for shielding radio waves inside guide portion (22, 22a, or 22b), and is disposed around support portion (21) along outer circumferential edges of placement surface (211). The driving portion drives support portion (21) so as to move RF tag (911) into the shielding space. Information acquisition device (3) acquires product information of product (91) from RF tag (911). Information acquisition device (3) includes an antenna (31, 31a, or 31b) that emits radio waves for communication with RF tag (911). Information acquisition device (3) reads product information from RF tag (911) by performing wireless communication with RF tag (911) using antenna (31, 31a, or 31b) when a relative positional relationship between a communication area of antenna (31, 31a, or 31b) and RF tag (911) changes in the shielding space, the communication area being an area which is set around antenna (31, 31a, or 31b) and in which wireless communication with RF tag (911) is performed.

Shopping assistance system (100) according to the first aspect performs wireless communication with RF tag (911) using antenna (31, 31a, or 31b) when a relative positional relationship between a communication area of antenna (31, 31a, or 31b) and RF tag (911) changes in the shielding space of guide portion (22, 22a, or 22b). Thereby, it is possible to reduce erroneous communication with an RF tag outside the shielding space. Further, a null point, which occurs by canceling of a radio wave directly received from antenna (31) and a reflected radio wave, can be compensated. Thus, accuracy of communication with RF tag (911) can be enhanced. Therefore, it is possible to acquire product information of product (91) with high accuracy.

In shopping assistance system (100) according to a second aspect of the present disclosure, in the first aspect, information acquisition device (3) reads the product information from RF tag (911) by performing wireless communication with RF tag (911) using antenna (31, 31a, or 31b) when RF tag (911) moves in the shielding space.

Shopping assistance system (100) according to the second aspect performs wireless communication with RF tag (911) using antenna (31, 31a, or 31b) when RF tag (911) moves in the shielding space. Thereby, compared with a case of performing wireless communication with RF tag (911) after RF tag (911) is moved, a null point, which occurs by canceling of a radio wave directly received from antenna (31, 31a, or 31b) and a reflected radio wave, can be compensated. Thus, accuracy of communication with RF tag (911) can be enhanced. Therefore, it is possible to acquire product information of product (91) with high accuracy.

In shopping assistance system (100) according to a third aspect of the present disclosure, in the first or second aspect, shopping basket (92) is further included. Shopping basket (92) includes basket main body (921) and bottom portion (bottom plate 922), and product (91) is put in shopping basket (92). The bottom portion is attached to basket main body (921) so as to open and close a lower opening portion of basket main body (921). Product (91) put in shopping basket (92) is placed on placement surface (211). Moving device (bagging device 2, or moving device 2a or 2c) moves RF tag (911) into the shielding space via the lower opening portion when the bottom portion is opened.

Shopping assistance system (100) according to a third aspect moves RF tag (911) into the shielding space via the lower opening portion of shopping basket (92). Thereby, it is possible to efficiently move RF tag (911) into the shielding space.

In shopping assistance system (100) according to a fourth aspect of the present disclosure, in the first or second aspect, shopping basket (92a) is further included. Product (91) is put in shopping basket (92a). Moving device (2b) moves RF tag (911) into the shielding space together with shopping basket (92a).

Shopping assistance system (100) according to the fourth aspect moves RF tag (911) into the shielding space together with shopping basket (92a). Thereby, it is possible to easily move RF tag (911).

In shopping assistance system (100) according to a fifth aspect of the present disclosure, in any one of the first to fourth aspects, information acquisition device (3) changes an intensity of the radio wave emitted by antenna (31, 31a, or 31b) in accordance with shielding performance of the shielding space.

In shopping assistance system (100) according to the fifth aspect, it is possible to change an intensity of the radio wave in consideration of shielding performance of the radio wave in the shielding space that changes in accordance with a movement position of RF tag (911).

In shopping assistance system (100) according to a sixth aspect of the present disclosure, in any one of the first to fifth aspects, guide portion (22, 22a, or 22b) has a shielding function of absorbing or reflecting the radio wave emitted by antenna (31, 31a, or 31b).

In shopping assistance system (100) according to the sixth aspect, guide portion (22, 22a, or 22b) has a shielding function of absorbing or reflecting the radio wave emitted by antenna (31, 31a, or 31b). Thereby, it is possible to reduce leakage of radio waves to the outside of the shielding space.

In shopping assistance system (100) according to a seventh aspect of the present disclosure, in the sixth aspect, guide portion (22, 22a, or 22b) has a cylindrical shape, and includes a first opening portion and a second opening portion which face each other in a movement direction of support portion (21).

In shopping assistance system (100) according to the seventh aspect, guide portion (22, 22a, or 22b) can reduce leakage of radio waves to the outside of the shielding space without interfering with movement of RF tag (911).

In shopping assistance system (100) according to an eighth aspect of the present disclosure, in the seventh aspect, support portion (21) is formed of a material which absorbs or reflects the radio wave emitted by antenna (31, 31a, or 31b). Support portion (21) closes the second opening portion of guide portion (22, 22a, or 22b) when RF tag (911) moves into the shielding space.

In shopping assistance system (100) according to the eighth aspect, it is possible to reduce leakage of radio waves from the second opening portion of guide portion (22, 22a, or 22b).

In shopping assistance system (100) according to a ninth aspect of the present disclosure, in the seventh or eighth aspect, shutter (821) is further included. Shutter (821) is formed of a material which absorbs or reflects the radio wave emitted by antenna (31, 31a, or 31b), and covers the first opening portion of guide portion (22, 22a, or 22b).

In shopping assistance system (100) according to the ninth aspect, it is possible to reduce leakage of radio waves from the first opening portion of guide portion (22, 22a, or 22b).

In shopping assistance system (100) according to a tenth aspect of the present disclosure, in any one of the seventh to ninth aspects, shopping basket (92) is further included. Shopping basket (92) includes basket main body (921) and bottom portion (bottom plate 922), and product (91) is put in shopping basket (92). The bottom portion is attached to basket main body (921) so as to open and close a lower opening portion of basket main body (921). The bottom portion is formed of a material which absorbs or reflects the radio wave emitted from antenna (31, 31a, or 31b), and covers the first opening portion of guide portion (22, 22a, or 22b).

In shopping assistance system (100) according to the tenth aspect, it is possible to reduce leakage of radio waves from the first opening portion of guide portion (22, 22a, or 22b) by bottom portion (bottom plate 922) of shopping basket (92).

In shopping assistance system (100) according to an eleventh aspect of the present disclosure, in the tenth aspect, information acquisition device (3) changes an intensity of the radio wave emitted by antenna (31, 31a, or 31b) in accordance with a member covering the first opening portion of guide portion (22, 22a, or 22b).

In shopping assistance system (100) according to the eleventh aspect, for example, in a case of using a member having excellent shielding performance, it is possible to relatively increase the intensity of the radio wave emitted by antenna (31, 31a, or 31b).

In shopping assistance system (100) according to a twelfth aspect of the present disclosure, in any one of the first to eleventh aspects, antenna (31, 31a, or 31b) includes a plurality of antenna elements (patch antennas 311 or 34). The plurality of antenna elements are directive, and are disposed such that directions of directivity thereof are different from each other.

In shopping assistance system (100) according to the twelfth aspect, it is possible to reduce a leakage in communication with RF tag (911).

In shopping assistance system (100) according to a thirteenth aspect of the present disclosure, in any one of the first to twelfth aspects, antenna (31, 31a, or 31b) includes a plurality of antenna elements (patch antennas 311 or 34). Each of the plurality of antenna elements has polarization characteristics, and the plurality of antenna elements are disposed such that polarization directions thereof are different from each other.

In shopping assistance system (100) according to the thirteenth aspect, it is possible to accurately read RF tag (911) regardless of a direction of RF tag (911).

In shopping assistance system (100) according to a fourteenth aspect of the present disclosure, in the thirteenth aspect, radio waves emitted by the plurality of antenna elements (patch antennas 311 or 34) are circularly-polarized waves or elliptically-polarized waves.

In shopping assistance system (100) according to the fourteenth aspect, it is possible to accurately read RF tag (911) regardless of a position of RF tag (911) and regardless of a direction of RF tag (911).

In shopping assistance system (100) according to a fifteenth aspect of the present disclosure, in any one of the first to third aspects, packing device (bagging device 2) is further included. The packing device puts product (91) into a container (bag 7) when the moving device (bagging device 2) moves RF tag (911) into the shielding space.

In shopping assistance system (100) according to the fifteenth aspect, it is possible to perform reading of product information from RF tag (911) and bagging of product (91) at the same timing.

In shopping assistance system (100) according to a sixteenth aspect of the present disclosure, in the fifteenth aspect, sales system (4) is further included. Sales system (4) is configured to perform communication with a settlement processing system which performs settlement processing of product (91) based on the product information.

What is claimed is:

1. A shopping assistance system comprising:
a moving device including:
a support portion provided with a placement surface on which a product with a radio frequency (RF) tag is placed;
a guide portion which includes a shielding space for shielding radio waves inside the guide portion and is disposed around the support portion along an outer periphery edge of the placement surface; and
a driving portion which drives the support portion so as to move the RF tag into the shielding space; and;
an information acquisition device that includes an antenna that emits a radio wave for wireless communication with the RF tag, and acquires product information of the product from the RF tag,
wherein the information acquisition device reads the product information from the RF tag by performing the wireless communication with the RF tag using the antenna when a relative positional relationship between a communication area and the RF tag changes in the shielding space, the communication area being an area which is set around the antenna and in which the wireless communication with the RF tag is allowed.

2. The shopping assistance system according to claim 1,
wherein the information acquisition device reads the product information from the RF tag by performing the wireless communication with the RF tag using the antenna when the RF tag is moving in the shielding space.

3. The shopping assistance system according to claim 1, further comprising a shopping basket that accommodates the product, and includes:
a basket main body; and
a bottom portion attached to the basket main body so as to open and close a lower opening portion of the basket main body,
wherein the product put in the shopping basket is placed on the placement surface, and
wherein the moving device moves the RF tag into the shielding space via the lower opening portion when the bottom portion is opened.

4. The shopping assistance system according to claim 1, further comprising a shopping basket that accommodates the product,
wherein the moving device moves the RF tag into the shielding space together with the shopping basket.

5. The shopping assistance system according to claim 1,
wherein the information acquisition device changes an intensity of the radio wave emitted by the antenna in accordance with shielding performance of the shielding space.

6. The shopping assistance system according to claim 1,
wherein the guide portion has a shielding function of absorbing or reflecting the radio wave emitted by the antenna.

7. The shopping assistance system according to claim 6,
wherein the guide portion has a cylindrical shape, and is provided with a first opening portion and a second opening portion which face each other in a movement direction of the support portion.

8. The shopping assistance system according to claim 7,
wherein the support portion is formed of a material which absorbs or reflects the radio wave emitted by the antenna, and closes the second opening portion of the guide portion when the RF tag moves into the shielding space.

9. The shopping assistance system according to claim 7, further comprising a shutter that is formed of a material which absorbs or reflects the radio wave emitted by the antenna and that covers the first opening portion of the guide portion.

10. The shopping assistance system according to claim 7, further comprising a shopping basket that accommodates the product and includes:
a basket main body; and
a bottom portion which is attached to the basket main body so as to open and close a lower opening portion of the basket main body,
wherein the bottom portion is formed of a material which absorbs or reflects the radio wave emitted by the antenna, and covers the first opening portion of the guide portion.

11. The shopping assistance system according to claim 10,
wherein the information acquisition device changes an intensity of the radio wave emitted by the antenna in accordance with a member covering the first opening portion of the guide portion.

12. The shopping assistance system according to claim 1,
wherein the antenna includes a plurality of antenna elements each of which is directive, and
wherein the plurality of antenna elements are disposed such that directions of directivity of the plurality of antenna elements are different from each other.

13. The shopping assistance system according to claim 1,
wherein the antenna includes a plurality of antenna elements each having polarization characteristics, and
wherein the plurality of antenna elements are disposed such that polarization directions of the plurality of antenna elements are different from each other.

14. The shopping assistance system according to claim 13,
wherein a radio wave emitted by each of the plurality of antenna elements is a circularly-polarized wave or an elliptically-polarized wave.

15. The shopping assistance system according to claim 1, further comprising a packing device that puts the product into a container when the moving device moves the RF tag into the shielding space.

16. The shopping assistance system according to claim 15, further comprising a sales system configured to perform communication with a settlement processing system which performs settlement processing of the product based on the product information.
